(19) United States
(12) Patent Application Publication
(10) Pub. No.: US 2024/0080911 A1
(43) Pub. Date: Mar. 7, 2024

(54) Systems and Methods for Communicating Data in an Operational Environment

(71) Applicant: Science Applications International Corporation, Reston, VA (US)

(72) Inventors: Jubal A. Biggs, Summerville, SC (US); Gregory T. Fulton, Annandale, VA (US); Stephen R. Strong, Apex, NC (US)

(21) Appl. No.: 17/903,243

(22) Filed: Sep. 6, 2022

(51) Int. Cl. H04W 76/10; H04L 67/131

(52) U.S. Cl. CPC H04W 76/10; H04L 67/131; H04W 84/18

(57) ABSTRACT

Each of multiple personal area network (PAN) systems may comprise a hub computing device, an output device, and a plurality of sensors. The hub computing devices may form a mesh network and may communicate messages, via the mesh network, based on data from sensors of the PAN systems. The hub computing devices may cause the output devices to present visual displays based on messages received via the mesh network and/or based on messages associated with sensors in the same PAN system.

### BACKGROUND

In an operational environment, multiple individuals may be working together to carry out one or more operations to achieve some objective. There are numerous example of such operational environments. In a military context, for example, a squad or other group of military personnel may be working together to achieve some military objective (e.g., capture of some resource, demolition of some physical structure, neutralization of a hostile force, collecting intelligence about activities of a hostile force, etc.). In this and many other types of operational environments, it may be advantageous for individuals performing operations to communicate with one another and/or with other persons (e.g., commanders or other supervisory personnel).

### SUMMARY

This Summary is provided to introduce a selection of some concepts in a simplified form as a prelude to the Detailed Description. This Summary is not intended to identify key or essential features.

To provide each of multiple individuals in an operational environment with an updated, collaborative view of an operational environment based on data originating with different individuals, each of the multiple individuals may be equipped with a personal area network (PAN) system. Each PAN system may comprise a hub computing device, an output device, and a plurality of sensors. Each of the hub computing devices of the PAN systems may form a mesh network and may communicate messages, via the mesh network, based on data from sensors of the PAN systems. The messages communicated via the mesh network may be in a common messaging format. Each of the hub computing devices may comprise controller software configured to receive and process messages communicated via the mesh network, as well as messages associated with sensors in the same PAN system. Messages received by the controller software, whether received via the mesh network or locally, may be in a common messaging format. The hub computing devices may cause the output devices to present visual displays based on messages received by the controller software. The controller software may send, via the mesh network, messages associated with sensors in the same PAN system, and may forward messages received from other PAN systems.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIG. 1 is a diagram showing features of an example system for communicating data among a plurality of individuals in an operational environment.

FIG. 2 is a diagram showing an example individual and a corresponding personal area network (PAN) system from the example operational environment of FIG. 1.

FIG. 3 is a block diagram showing features of an example hub computing device of a PAN system.

FIGS. 4A and 4B are block diagrams showing software elements of an example hub computing device.

FIGS. 5A, 5B, and 5C show example steps that may be performed by an example PAN system controller software container.

FIGS. 6A, 6B, 6C, 6D, 6E, and 6F are communication flow diagrams showing several non-limiting examples of how data may be shared between software containers within the same hub computing device and/or between software containers of different hub computing devices.

### DETAILED DESCRIPTION

In many types of operational environments, and as mentioned above, it may be advantageous for individuals performing operations in the operational environment to communicate with one another and/or with other personnel or resources. A compact, portable computing device configured to carry out such communications would be extremely beneficial. For example, in a military combat operational environment, each of multiple individual operators in a squad or other unit may benefit from automatically receiving, displaying, and/or storing data indicating a status of the individual operator (e.g., that operator's position, objective, etc.) as well as the status of other operators in the unit (e.g., positions, health, etc.). Each of such operators may also benefit by sharing data that the operator may have collected (e.g., assets or targets that have been tagged or identified) with other operators in the unit.

Implementation of a portable computing device to achieve such benefits, whether in a military combat or other type of operational environment, poses many challenges. Communications between operators in a unit, and/or communications between one or more of those operators and persons or resources located elsewhere, may be intermittent and/or unpredictable. For this reason, channeling inter-operator communications via a central access point may be impractical or impossible. But even if the challenges of inter-operator and/or operator-remote resource communications could be solved, other challenges remain.

Even within a specific type of operational environment, there is a wide variety of types information that operators may wish to share, as well as a wide variety of devices from which operators may collect and/our output information. In a military environment, for example, there are numerous types of devices that may be used to collect positional data (e.g., Global Positioning System (GPS) data), image or video data, biometric data, and numerous other types of data. Even with regard to a particular type of data, that data may potentially be collectible from different devices (e.g., different models of devices and/or devices from different manufacturers). Configuring multiple portable computing devices to collect and share such data from numerous possible sources is a formidable obstacle. Similarly, there may be numerous different types of devices via which a portable computing device may output information to an operator, and configuring multiple portable computing devices to output information via numerous possible devices may be challenging.

Described herein are systems and methods that help overcome, in whole or in part, one or more of the above noted challenges. Each of multiple operators in an operational environment may be provided with a hub computing device, as well as with one or more sensors to collect data and one or more devices to output information to the operator. Each of the operator's hub computing device, sensor(s), and output device(s) may be connected to form a personal area network (PAN) system. Each of the PAN systems may be connected (or connectable) to a mesh network. Each of the hub computing devices may be configured to receive data from sensors in that hub computing device's PAN system, to share that data locally with other sensors and/or output devices, and to communicate that data via the mesh network to other hub computing devices. Each of the hub computing devices may be further configured to receive data via the mesh network and to output such data via output devices and/or to other sensors. As further described below, software containers and a common messaging format may be used. Additional features and advantages are described below, and/or will be apparent based on the description herein and the drawing figures.

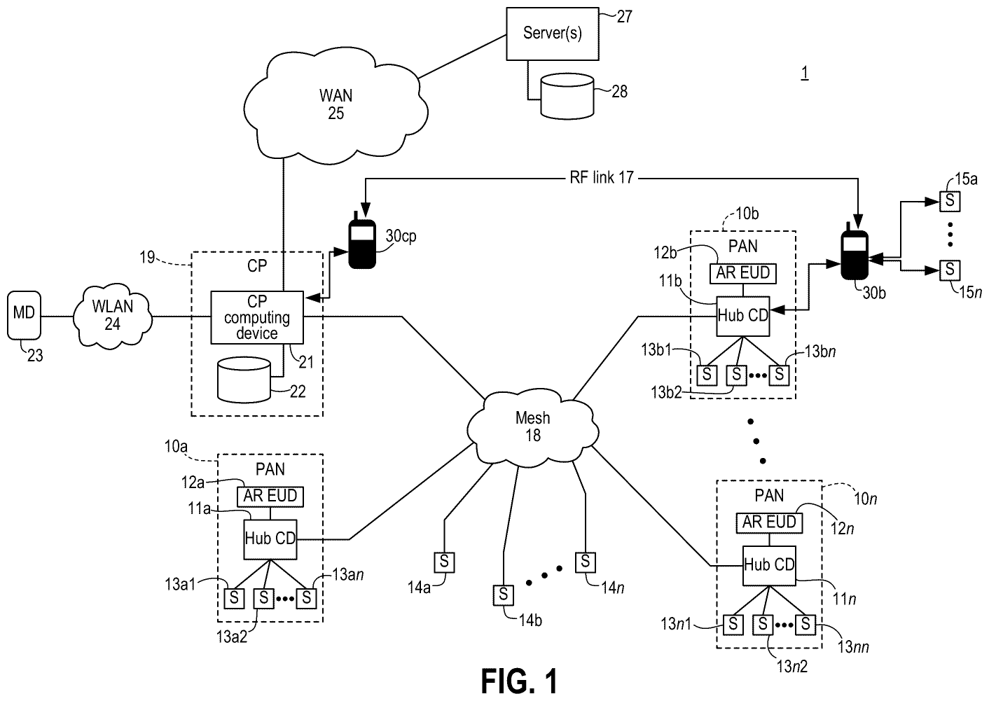

FIG. 1 is a block diagram showing features of an example system 1 for communicating data among a plurality of individuals in an operational environment. The system 1 may comprise a plurality of additional systems such as, for example, a plurality of PAN systems as described below. In the example of FIG. 1, the operational environment is a military environment (e.g., a battlefield), and description of FIG. 1 and subsequent figures will be in the context of such an operational environment. However, and as further explained below, systems such as system 1 (or portions thereof) may be used to communicate data among individuals in numerous other types of operational environments.

Various similar elements shown in the drawing figures have similar reference numbers that include appended incremental letter or numeral portions. Elements having a similar reference number may be collectively or generically referred to using the similar portion of the elements' reference numbers. For example, PAN systems 10a through 10n may be collectively referred to as the PAN systems 10, and an arbitrary one of those the PAN systems 10 may be referred to as a (or the) PAN system 10. In FIG. 1 and subsequent drawing figures, the letter “n” is used with elements having a similar reference number to indicate an arbitrary quantity of additional similar elements. The letter “n” need not represent the same quantity everywhere it is used. A series of three dots is used in the drawing figures to indicate the possible presence of one or more additional elements that are similar to elements on one or both ends of the series of three dots.

As indicated above, the system 1 comprises a plurality of PAN systems 10a, 10b, etc., through 10n. Each of the PAN systems 10 may be deployed in the operational environment and may correspond to (e.g., may be carried by) an individual operating in the environment. In the example of FIG. 1, each of the PAN systems 10 may correspond to an individual operator (e.g., a soldier) in a squad or other group of operators. Although the example of FIG. 1 shows at least three PAN systems 10 corresponding to at least three operators, there may be fewer PAN systems 10 and corresponding operators. Each of the PAN systems 10 may comprise a hub computing device 11 (e.g., hub computing devices 11a, 11b, . . . 11n). As explained in more detail below, each of the hub computing devices 11 may comprise one or more processors and memory storing instructions that, when executed by the one or more processors, cause the hub computing device 11 to perform functions such as are described herein.

Each of the PAN systems 10 may comprise an Augmented Reality End User Device (AR EUD) 12 (e.g., AR EUDs 12a, 12b, . . . 12n). Each of the AR EUDs 12 may be communicatively coupled to the hub computing device 11 in its respective PAN system 10 (e.g., the AR EUD 12a of the PAN system 10a may be communicatively coupled to hub computing device 11a). Each of the AR EUDs 12 may be used to display information to a corresponding operator, as further described below.

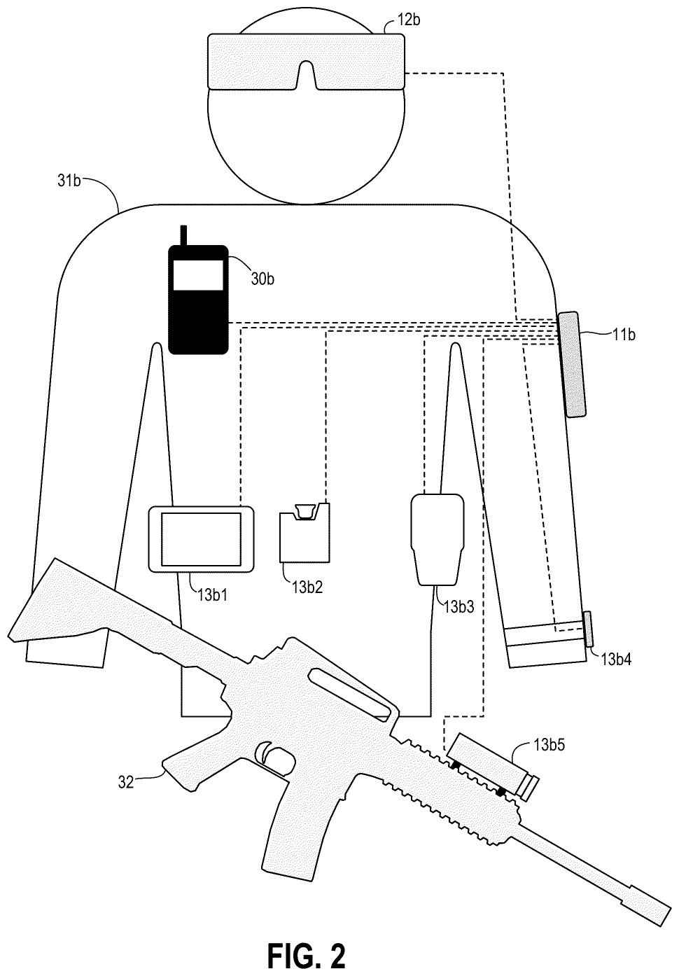

Each of the PAN systems 10 may also comprise one or more sensors (S) 13. In the example of FIG. 1, the PAN system 10a comprises sensors 13a (e.g., sensors 13a1, 13a2, . . . 13an) communicatively coupled to the hub computing device 11a, the PAN system 10b comprises sensors 13b (e.g., sensors 13b1, 13b2, . . . 13bn) communicatively coupled to the hub computing device 11b, etc., with the PAN system 10n comprising sensors 13n (e.g., sensors 13n1, 13n2, . . . 13nn) communicatively coupled to the hub computing device 11n. Each of the sensors 13 may comprise any device configured to collect and/or output data. A sensor may output data to another device and/or software component, and/or may output data to a human user (e.g., as visually perceptible elements on a display screen and/or as sound). A sensor may collect data by detecting and/or quantifying some physical characteristic, and/or by generating data based on the detected and/or measured physical characteristic. For example, a camera may detect light, may quantify that light (e.g., intensity and wavelength), and may generate data in the form of image and/or video data based on the detected/quantified light. As but another example, a biometric sensor may detect a heartbeat and quantify a heart rate, and may generate data in the form of a numeric value for that heart rate. Also or alternatively, a sensor may collect data by receiving input (e.g., manual text input, voice input) from a user and may generate data that represents the received input. Additional examples of sensors are described below in connection with FIG. 2. A sensor may itself comprise one or more processors and memory storing instructions that, when executed one or more processors, cause the sensor to perform data collection, generation, output, and/or reporting functions. A sensor may comprise an actuator that may be used to control another device, which actuator may be actuated/triggered by a hub computing device 11 to which the sensor is connected, and/or via the mesh network 18 by another hub computing device 11. For example, a sensor may comprise a mechanical and/or electrical actuator that may be used to control one or more other devices such as a weapon.

The hub computing devices 11 of the PAN systems 10 may communicate with one another via a mesh network 18. The mesh network 18 may be fully connected (e.g., every node (e.g., hub computing device 11) of the mesh network 18 may be connected to every other node of the mesh network 18) or may be partially connected (e.g., every node may be connected to at least one other node, some nodes connected to multiple nodes). One or more of the hub computing devices 11 may connect, disconnect, and reconnect to the mesh network 18 (e.g., as hub computing devices 11 enter or leave wireless communication range of each other). The communications between the hub computing devices 11 via the mesh network 18 may be via one or more wireless communication interfaces and/or protocols. For example, the mesh network 18 may be a mesh network in which data is communicated via a wireless protocol that uses long range (LoRa) modulation (e.g., as described in U.S. Pat. No. 9,647,718).

The system 1 may further comprise one or more sensors 14 (e.g., sensors 14a, 14b, . . . 14n) that may be connected to the mesh network 18 separately from a PAN system 10. The sensor(s) 14 may comprise sensors that are similar in type to sensors 13, but that are independent of any particular PAN system 10. For example, a sensor 14 may comprise a camera associated with an unmanned aerial vehicle (UAV) (e.g., a drone) or a fixed location, a sensor placed at location and configured to monitor some physical parameter (e.g., heat, light, air quality, radiation, noise) at that location, a global positioning system (GPS) tracking sensor affixed to a vehicle, etc. One or more of the sensors 14 may also connect, disconnect, and reconnect to the mesh network 18 and may communicate data via a common messaging format described herein.

The system 1 may additionally comprising a command post (CP) system 19. The CP system 19 may comprise CP computing device 21. The CP computing device 21, which may be similar to the hub computing devices 11, and which may comprise a cluster of hub computing devices 11 and/or may comprise another type of computing device, may comprise one or more processors and memory storing instructions that, when executed by the one or more processors, cause the CP computing device 21 to perform functions such as those described herein. The functions of the computing device 21 may comprise communicating with one or more of the hub computing devices 11 and/or sensors 14 via the mesh network 18, communicating via one or more additional Wireless Local Area Networks (WLAN) 24 with one or more mobile devices (MD) 23, and/or communicating via one or more Wide Area Networks (WAN) 25 with one or more servers 27 and/or databases 28. The WAN(s) 25 may comprise the Internet, one or more other terrestrial wired and/or wireless networks, and/or a satellite network. The CP system 19 may comprise one or more satellite transceivers (not shown) and/or other hardware to communicate via the WAN(s) 25. Also or alternatively, the CP computing device 19 may be configured to communicate via one or more radio frequency (RF) links 17, separate from the mesh network 18, using one or more RF communication devices 30cp. An RF communication device 30 may, for example, comprise a device used for tactical and/or encrypted communications (e.g., an AN/PRC-152 multiband handheld radio, an AN/PRC-148 multiband inter/intra team radio, an RT-1922 radio, and/or other type of radio). An RF communication device 30cp associated with the CP system 19 may form an RF link 17 with, for example, another RF communication device 30 associated with one of the PAN systems 10. For example, the hub computing device 11b of the PAN system 10b may be connected (e.g., via a Universal Serial Bus (USB) and/or other wired or wireless interface) to an RF communication device 30b. The RF communication device 30b may be connected (e.g., via one or more wired or wireless connections) with one or more additional sensors 15a . . . 15n, which sensors may be of a type similar to one or more of sensors 13 or 14. Also or alternatively, the RF communication device 30b provide the hub computing device 11b with voice and/or data communications with one or more other entities (e.g., one or more aircraft-borne entities, one or more ship-borne entities, etc.).

The functions of the CP computing device 21 may comprise receiving data (e.g., sensor data, text, and/or other communications) from the PAN systems 10, the sensors 14, and/or the sensors 15 via the mesh network 18 and/or via RF link(s) 17. The functions of the CP computing device 21 may comprise transmitting data (e.g., instructions, text or other communications, graphical, video, and/or audio data, sensor configuration data, software updates, etc.) to the PAN systems 10, the sensors 14, and/or the sensors 15 via the mesh network 18 and/or via RF link(s) 17. The functions of the CP computing device 21 may comprise sending data (e.g., data received via the mesh network 18 and/or RF link(s) 17) to one or more mobile devices 23 and/or servers 27 and/or receiving data (e.g., instructions, text or other communications, graphical, video, and/or audio data, sensor configuration data, software updates, etc.) from one or more server(s) 27 and/or mobile devices 23 for relay to the PAN systems 10 and/or to the sensors 14 and/or 15. The CP computing device 21 may store (e.g., in one or more databases 22) some or all of the data it receives.

FIG. 2 is a diagram showing additional details of the PAN system 10b and a corresponding operator 31b. Other PAN systems 10, corresponding to other operators 31, may be similar. However, the PAN systems 10 need not be identical. One, some, or all of the PAN systems 10 may have different types of sensors 13, different combinations of types of sensors 13, and/or different quantities of sensors 13. The hub computing devices 11 may store different types of software corresponding to different types of sensors, and/or may otherwise store different types of data. Any of the PAN systems 10 may comprise additional elements (e.g., additional types of sensors) different from those shown in FIG. 2, and/or may lack one of more of the elements shown in FIG. 2.

The hub computing device 11b may comprise a computer contained in a ruggedized case and sized to be held in a pocket of an operator's clothing. The hub computing device 11b may comprise one or more wired and/or wireless interfaces for communication with sensors 13b, with the AR EUD 12b, with the RF communication device 30b, and/or with one or more other devices. FIG. 2 shows communication connections between the hub computing device 11b and other devices as broken lines that may represent either wired or wireless connections. The AR EUD 12b may comprise an augmented reality visor comprising a screen through which an operator may view the external environment. A projector of the AR EUD 12b may display text and/or other images onto a surface of that screen, resulting in a view to the operator 31b that comprises the external environment with superimposed data and/or images. Examples of devices that may be used as an AR EUD include smart glasses available from Microsoft Corporation under the name “HoloLens 2,” from Google LLC under the name “Glass Enterprise Edition,” and from Vuzix Corporation, ThirdEye Gen, Inc., and other providers under various other names.

In the example of FIG. 2, the sensor 13b1 may comprise a tablet type input device (and/or a smart phone) via which the operator 31b may input text and via which graphical, image, video, and/or textual information may be output to the operator 31b. The sensor 13b2 may comprise a rangefinder such as, for example, a Pocket Laser Rangefinder (PLRF). The sensor 13b3 may comprise a global positioning device such as a Defense Advanced GPS Receiver (DAGS). The sensor 13b4 may comprise a smart watch with one or more biometric sensors configured to output biometric data (e.g., heart rate, body temperature). The smart watch of the sensor 13b4 may also or alternatively be configured to receive text and/or other input data from the operator 31b and/or to output text and/or graphical/image/video information. The sensor 13b5 may comprise a camera and/or other imaging device (e.g., an infrared (IR) imaging device) mounted on a weapon 32.

The sensors 13b1 through 13b5 are only some examples of sensors that may be included in a PAN system 10 and/or used as a sensor 14 or 15. As previously indicated, a sensor may comprise any device that is configured to collect and output data. In addition to the examples provided above, examples include, without limitation, microphones and/or other sound sensors, hydrophones, seismic sensors, radar sensors, sonar sensors, LIDAR sensors, proximity sensors, magnetic sensors, facial recognition scanners, other types of biometric sensors, voice recognition devices configured to convert speech to text, other types of devices configured to output data based on text and/or other input from a user, sensors configured to monitor one or more conditions of an engine or other mechanical device, and environmental sensors (e.g., sensors configured to monitor temperature, humidity, wind speed, visibility, precipitation, and/or other environmental condition).

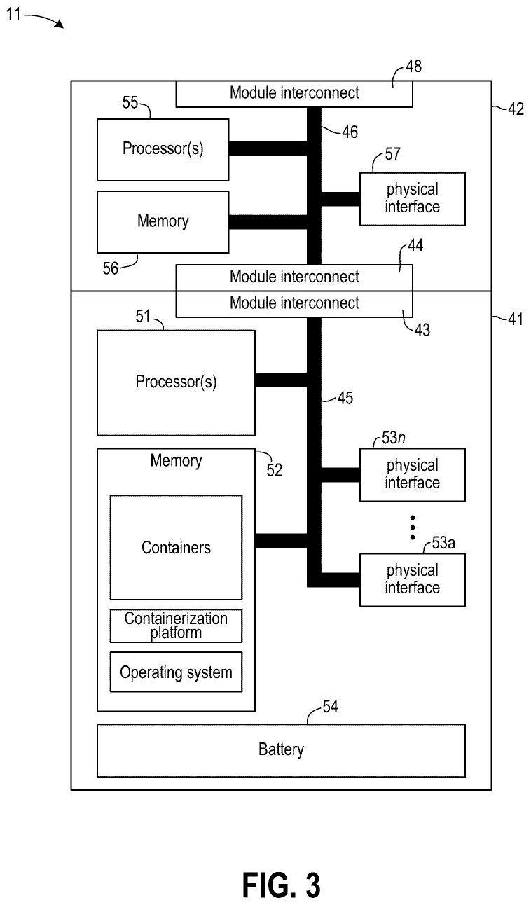

FIG. 3 is a block diagram showing features of an example hub computing device 11. The hub computing device 11 may be modular and may comprise a base unit 41 and one or more modules 42. A module 42 may be connected to the base unit 41 via complementary module interconnect plugs 43 (attached to the base unit 41) and 44 (attached to the module 42). The interconnect plug 43 may comprise a plurality of connectors that mate with connectors of the interconnect plug 44 to electrically connect a data bus 45 of the base unit 41 to a data bus 46 of the module 42. A module 42 may be connected to the base unit 41 to provide additional processing and/or memory capacity. Also or alternatively, and as described below, a module 42 may be connected to the base unit 41 to add a physical interface. One or more additional modules 42 may be added by joining the module interconnect plug 48, which may be similar to the interconnect plug 43 of the base unit 41, to an interconnect plug 44 of another module 42.

The base unit 41 may comprise one or more processors 51. The processor(s) 51 may, for example, comprise x86 or x86-compatible processor(s). The base unit 41 may further comprise memory 52. The memory 52 may comprise one or more non-transitory, physical memories of any type (e.g., volatile, non-volatile). The memory 52 may, for example, comprise FLASH memory, one or more solid state drives (SSDs), and/or other types of memory. The memory 52 may store instructions that, when executed by the processor(s) 51, cause the base unit 41 to perform some or all functions of a hub computing device 11 such as are described herein. The stored instructions may comprise an operating system, which may comprise a Linux-based, Windows-based, Unix-based, and/or other type of operating system. The stored instructions may also or alternatively comprise multiple software containers and a containerization platform via which the software containers may communicate with each other and/or with other resources (e.g., via the operating system), as described in more detail below.

The base unit 41 may also comprise one or more physical interfaces 53a through 53n. A physical interface 53 may be wired or wireless. A wired physical interface 53 may comprise a plug or other connector compatible with a protocol associated with the physical interface, as well as circuitry to convert signals received via the connector into digital data for communication to the processor(s) 51 and to convert digital data received from the processor(s) 51 into signals for output via the interface connector. The base unit 41 may comprise one or more wired interfaces 53 associated with a USB protocol, with an Ethernet protocol, and/or with another type of wired protocol. A wireless physical interface 53 may comprise a transceiver for sending and receiving RF (or light) signals compatible with a protocol associated with the physical interface, as well as circuitry to demodulate received RF (or light) signals into digital data for communication to the processor(s) 51 and to modulate digital data received from the processor(s) 51 into RF (or light) signals for transmission. The base unit 41 may comprise one or more wireless interfaces 53 associated with a Wireless Local Area Network (WLAN) protocol (e.g., WiFi, an IEEE 802.11 protocol, etc.), a WiMAX protocol (e.g., an IEEE 802.16 protocol), a BLUETOOTH protocol, a LoRaWAN protocol (or other protocol using LoRa modulation), a Long Term Evolution (LTE) protocol, a 5G protocol, a laser and/or other light-based communication protocol (e.g., a free space optical (FSO) communication protocol), and/or another type of wireless protocol. The processor(s) 51, memory 52, and physical interface(s) 53 may communicate via the data bus 45. A battery 54 may power the base unit 41, the module 42, and one or more additional module(s) (if present).

The module 42 may comprise one or more processors 55, memory 56, and one or more physical interfaces 57 that communicate via the data bus 46. The memory 56 may store instructions (e.g., an operating system, a containerization platform, one or more software containers) that, when executed by the processor(s) 55, cause the module 42 to perform some or all functions of a hub computing device 11 such as are described herein. Also or alternatively, the processor(s) 55 may execute instructions stored by the memory 52, and/or the processor(s) 51 may execute instructions stored by the memory 56, to perform some or all functions of a hub computing device 11 such as are described herein. The physical interface(s) 57 may comprise any type of wired or wireless interface such as described above for the physical interface(s) 53. The base unit 41 may be connectable to one or more different types of module 42. Each of the different types of modules 42 may be configured to perform some portion of the functions of a hub computing device 11. For example, a base unit 41 may lack a particular type of physical interface (or may lack any physical interface), and different types of module 42 may be configured to add interfaces of particular types. If, for example, the base unit 41 lacks a wireless physical interface 53, a module 42 comprising a wireless physical interface 57 may be connected to the base unit 41. As another example, if a hub computing device is expected to perform functions that require additional processing or memory capacity, a module 42 could be added to augment the capacities of the processor(s) 51 and the memory 52.

As indicated above, software stored in memory of a hub computing device 11 may take the form of software containers. A software container is a specialized software package that comprises one or more applications (the contained application(s)), and that further comprises all dependent software elements that may be needed to execute the contained application(s). The dependent elements may include system libraries, runtime libraries, binary files, third-party code packages, system tools, settings, and/or other applications that might normally reside in an operating system. Types of containers include, without limitation, DOCKER containers and Kubernetes containers. Containers may run (execute) in a containerization platform, which may comprise software that allows the containers to communicate with each other and to access, via an operating system (or operating system kernel) of a host computing device, hardware resources (e.g., processor(s), physical interface(s)) of the host computing device. The containerization platform may create a container based on a container image file, stored in a container registry, that comprises a read-only template defining the application(s) and dependencies of the container. An example of a containerization platform is the DOCKER ENGINE runtime environment software.

Software containers offer numerous advantages. Software containers are relatively lightweight, as their contents may be confined to what is needed for a particular containerized application (or set of applications), and because they may rely on a host operating system kernel. Software containers are also more easily deployed than other types of software packages, and can be used across multiple computing environments. Because software containers can be used across different environments, developing applications for specialized functions (e.g., interacting with a particular type of sensor) may be simplified.

Software containers may be used to package some or all applications associated with a hub computing device 11 of a PAN system 10. A single software container may contain multiple applications performing multiple varied functions, or may comprise a limited number of applications (or even a single application) performing a limited number of functions (or even a single function). Each sensor 13 may correspond to its own software container, each output device (e.g., an AR EUD 12) may correspond to its own software container, etc. Also or alternatively, a single container may correspond to multiple sensors 13 and/or other devices. Container architecture allows, for example, a hub computing device 11 to be easily configurable to use any of a large range of possible sensors 13 and/or output devices. It also facilitates specialization of PAN systems 10 on a user-by-user basis according to individualized requirements. For example, an operator associated with one of the PAN systems 10 may need a particular set of sensors to carry out mission objectives assigned to that operator, but a different operator associated with another of the PAN systems 10 may need a different set of sensors to carry out different mission objectives assigned to that different operator. Each operator's respective hub computing device 11 may be configured by loading software containers corresponding to the sensors that the respective operator will need. Moreover, and as described below, use of a common messaging format by all of the software containers allows a hub computing device 11 of a first PAN system 10 to process sensor data from sensors 13 of a second PAN system 10, even if the second PAN system 10 sensors 13 are of a type not used by the first PAN system 10, and even if the first PAN system 10 lacks software containers corresponding to those sensors of the first PAN system 10.

In addition to sensors and output devices, software containers may be used for other types of applications in a hub computing device 10. Examples of such applications comprise applications (e.g., facial or object recognition software) configured to process image data from a sensor and output data based on the processing, encryption/decryption applications, text recognition applications, artificial intelligence applications, applications that analyze/process target data and/or control other devices (e.g., weapons) based on target data, speech detection recognition applications, applications using one or more simultaneous localization and mapping (SLAM) algorithms, etc.

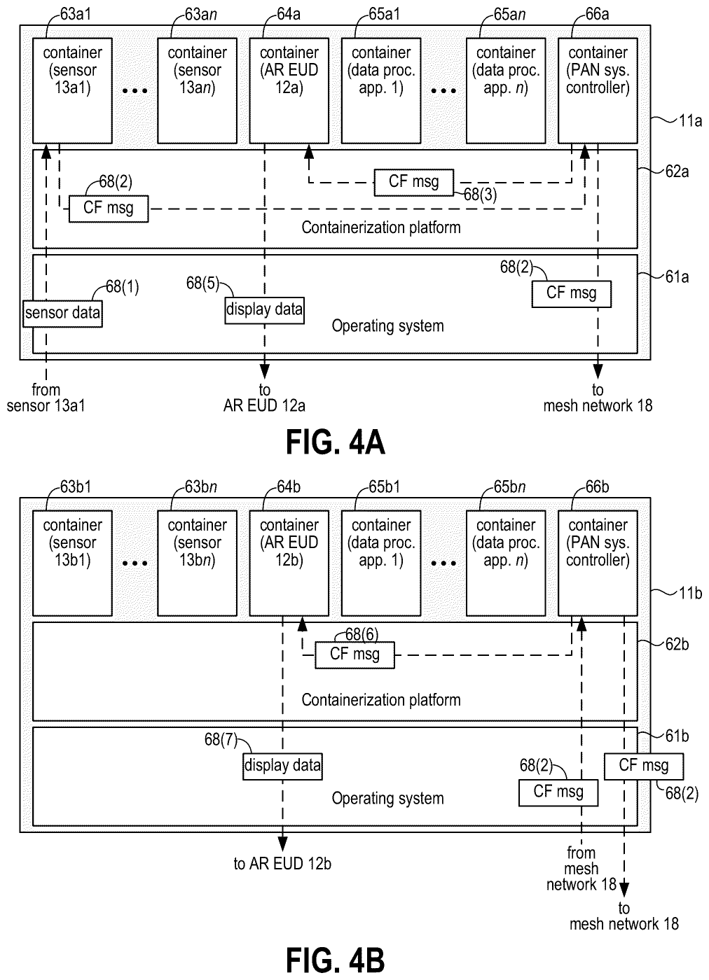

FIG. 4A is a block diagram showing software elements of the hub computing device 11a. Those elements comprise an operating system 61a, a containerization platform 62a, and a plurality of software containers 63a1 through 63an, 64, 65a1 through 65an, and 66. The operating system 61 and the containerization platform 62 may be similar to the operating system and containerization platform described in connection with FIG. 3. Each of the software containers 63a may correspond to a different sensor 13a of the PAN system 10a.

Each of the software containers 63a may be configured to receive, via one of the physical interfaces 53 or 57, sensor data from its corresponding sensor 13a. That received sensor data may be received in a format that corresponds to an application programming interface (API) associated with that sensor, which format and API may be different from formats and APIs used by other sensors. After receiving sensor data from its corresponding sensor, a software container may convert the sensor data to a common messaging format that may be used and recognized by all software containers of the hub computing device 11a, as well as by all software containers of all hub computing devices 11 in the mesh network 18. For convenience, “common-formatted message” (or CF message) will refer to a message that is formatted in accordance with such a common messaging format. Additional features of an example common messaging format are described below.

A software container 63a may also perform functions in addition to converting received sensor data to a common messaging format. A software container 63a may also or alternatively perform one or more types of data processing on received sensor data and may output (e.g., in the common messaging format) the result of that processing instead of or in addition to the sensor data received from the sensor. For example, the received sensor data may comprise image data from one or more images of a camera. A corresponding software container 63a may process the received image data to remove artifacts, crop the image(s), enhance contrast, and/or otherwise modify the original image data, and may output the modified image data. As another example, received sensor data may comprise measurements or other values based on first system of units and/or relative to a first reference value, and a corresponding software container 63a may process the received sensor data to be based on different units (e.g., meters instead of yards) or relative to a different reference value.

The software container 64a may be configured to output, via a physical interface of the hub computing device 11a, commands and/or other data to the AR EUD 12a. Commands may comprise, for example, commands to zoom in, zoom out, adjust brightness, change color, change displayed objects, etc. Other data may comprise text, image data, and/or other graphics to be output via the AR EDU 12a. Those commands and/or other data output by the software container 64a may be in a format that corresponds to an API of the AR EUD 12a, which format and/or API may have been defined by a manufacturer of the AR EUD hardware and/or different from APIs and formats used by sensors or other elements of a PAN system. The software container 64a may be further configured to receive common-formatted messages from another container and to generate, based on such received common-formatted messages, the commands and/or data output to the AR EUD 12a.

The software containers 65a1 through 65an may comprise different applications that perform various functions, but that may not necessarily be specific to a particular sensor. For example, a software container 65a1 may include an application that performs facial recognition, object recognition, or other type of recognition processing based on image data. However, that recognition application may potentially be usable with image data from any of a variety of different types of sensors that include cameras. By packaging the recognition software in a separate software container configured to receive image data (in a common-formatted message) from another container and to output (in a common-formatted message) results of such recognition processing, the recognition processing capability is not tied to a particular sensor and software containers associated with imaging sensors need not be enlarged with additional software for recognition processing. As but another example, a software container 65a may include a medical application that performs diagnostic functions based on biometric data (e.g., heart rate, blood pressure, temperature) from one or more software containers corresponding to one or more biometric sensors, based on text from one or more containers corresponding to one or more sensors allowing a user to provide text input, and/or based on other data from other containers. Such a software container 65a may, for example, be installed on a hub computing device 11 of a PAN system 10 corresponding to a medic in a military unit. The software container 65a with the medical application may receive input data in the common messaging format (thereby allowing for input from a wide variety of different sensors) and may output results in the common messaging format (thereby allowing for output via a wide variety of display and/or communication devices).

The software container 66a may comprise one or more applications for performing various control functions of the PAN system 10a corresponding to the hub computing device 11a. Those functions may include, without limitation, receiving common-formatted messages from other software containers, forwarding received common-formatted messages to other software containers and/or to other hub computing devices 11 (e.g., via the mesh network 18 connecting one or more hub computing devices 11), generating new common-formatted messages based on received common-formatted messages and sending those new common-formatted messages to other software containers and/or to other hub computing devices 11 (e.g., via the mesh network 18), monitoring/establishing/discontinuing connectivity to the mesh network 18 (and/or to other networks), tracking all software containers installed on the hub computing device 11a, and/or determining which messages are sent to which software containers and/or to which other hub computing devices. The software container 66a may determine which messages to forward or send, as well as the software containers and/or other hub computing devices 11 to which such messages should be sent or forwarded, based on information in messages received by the software container 66a. As explained in more detail below, such information (e.g., topic, identifier of the sensor 13a1 associated with the message, identifier of the PAN system 10a associated with the message, a time of the message) may be defined by the of the common messaging format.

The software container 66a may comprise one or more applications for maintaining an operational model, of the operational environment in which the PAN system 10a is currently operating, maintained by the hub computing device 11a. The operational model may be based on location data, communications, and/or other types of sensor data from accumulated common-formatted messages received from containers in the hub computing device 11a and from other hub computing devices 11. The operational model may reflect a state of the operational environment (or portion thereof) based on information received by the hub computing device 11a. The operational model may also be based on instructions, orders, objectives, maps, and/or other information received from the CP system 19 and/or from other sources, and/or based on other information. Each of the hub computing devices 11 may maintain its own operational model that is updated based on common-formatted messages received from software containers of that hub computing device 11 and/or from other hub computing devices 11. The operational models maintained by any two of the hub computing devices 11 may be similar, but may have differences based on, for example, timing of when messages containing data associated with other hub computing devices are received, whether mesh network 18 connectivity has been lost, etc.

Other hub computing devices 11 may comprise software elements that are the same as or similar to the software elements shown in FIG. 4A. For example, each of the hub computing devices 11 may comprises software containers corresponding to each of the sensors 13 of the PAN system 10 associated with the hub computing device 11, a software container corresponding to the AR EUD 12 of that PAN system 10, software containers comprising data processing applications, and a software container, similar to the software container 66a, for performing various control functions of the PAN system 10 associated with the hub computing device 11. However, there may be differences between the collections of software containers of any two hub computing devices 11. For example, a first PAN system 10 may have a particular type of sensor 13 that a second PAN system 10 lacks. In such a case, the hub computing device 11 of the first PAN system 10 may have a software container corresponding to that sensor type, but the hub computing device 11 of the second PAN system 10 may lack such a software container. As another example, a first sensor 13 of a first PAN system 10 and a second sensor 13 of a second PAN system 10 may be of the same type, but may be different models and/or from different manufacturers. In such a case, a software container corresponding to the first sensor 13 may be different from a software container corresponding to the second sensor 13. Similarly, if two PAN systems 10 comprise different AR EUDs 12 (e.g., different models, different types, from different manufacturers), the software containers corresponding to those different AR EUDs 12 may be different. As a further example, a hub computing device 11 may comprise one or more software containers comprising data processing applications, and another hub computing device may lack those one or more software containers.

FIG. 4A also shows an example of how common-formatted messages may be used by a hub computing device 11a of the PAN system 10a. The software container 63a1 may receive, via a physical interface 53 or 57 and operating system 61a of the hub computing device 11a, a message 68(1) that comprises sensor data from the sensor 13a1 corresponding to the software container 63a1. The message 68(1) may be in a format, and/or received via an API, that is unique to the sensor 13a1. Based on the sensor data in the message 68(1), the software container 63a1 may generate a common-formatted message 68(2) and send, via a rest API associated with the containerization platform 62a and the common messaging format, the message 68(2) to the software container 66a. To generate the message 68(2), the software container 63a1 may extract sensor data from the message 68(1) and add that extracted data (and/or additional data derived from converting and/or otherwise processing the sensor data) and other data to the message 68(2). The other data may include additional data items required by the common messaging format. Such additional items may include an identifier of the sensor 13a1, an identifier of the PAN system 10a, a time associated with the sensor data (e.g., a time associated with receipt of the message 68(1) by the software container 63a1, and/or a time associated with generation of the message 68(2)), and a topic associated with the sensor data and/or with the sensor 13a1.

Based on receiving the message 68(2) and based on data from the message 68(2), the software container 66a may update the operational model maintained by the hub computing device 11a. The software container 66a may also determine whether data from (or based on) the message 68(2) should be sent to other containers of the hub computing device 11a and/or to other hub computing devices 11. In the example of FIG. 4A, the software container 66a determines that messages should be sent to the container 64a, and also sent, via the mesh network 18, to other hub computing devices 11. The software container 66a generates a common-formatted message 68(3) that includes data, based on the data from the message 68(2), indicating how a visual display being output via the AR EUD 12a should be modified. If sensor 13a1 is a GPS sensor, for example, the visual display may be modified to change a location on a map grid or to change another visual indicator of a position associated with the PAN system 10a (or of an operator associated with the PAN system 10a). The software container 66a sends the message 68(3) to the container 64a and forwards the message 68(2), via the mesh network 18, to one or more other hub computing devices 11. Alternatively, the software container 66a may generate a new common-formatted message that comprises sensor data (or sensor-based data), an identifier of the sensor 13a1, the topic, the time, and the PAN system identifier from the message 68(2), and send that new message via the mesh network 18 instead of forwarding the message 68(2). Based on receiving the message 68(3), the software container 64a generates a message 68(5) that comprises display data from (or based on) data from the message 68(3), and that will cause the AR EUD 12a to modify a visual display that is being output. The message 68(5) may be in a format, and/or sent via an API, that is unique to the AR EUD 12a.

FIG. 4B shows an example of how the message 68(2) and other common-formatted messages may be used by the hub computing device 11b of the PAN system 10b. As shown in FIG. 4B, the hub computing device 11b may comprise software containers 63b1 through 63bn respectively corresponding to sensors 13b1 through 13bn, software container 64b corresponding to the AR EUD 12b, software containers 65b1 through 65bn corresponding to data processing applications, and software container 66b. The software containers 63b1 through 63bn, 64b, 65b1 through 65bn, and 66b may operate in manners similar to those described above for the software containers 63a1 through 63an, 64a, 65a1 through 65an, and 66a, respectively. The hub computing device 11b may similarly comprise an operating system 61b and a containerization platform 62b that are respectively similar to the operating system 61a and the containerization platform 62a.

The software container 66b may receive, via a physical interface 53 or 57 and the operating system 61b of the hub computing device 11b, the message 68(2). Hub computing devices 11 may use MQTT, gRPC, SignalR, WebSocket, REST, and/or other protocols to communicate messages via the mesh 18. Based on receiving the message 68(2) and based on data from the message 68(2), the software container 66b may update the operational model maintained by the hub computing device 11b. The software container 66b may also determine whether data from (or based on) the message 68(2) should be sent to other containers of the hub computing device 11b, as well as whether the message 68(2) should be forwarded to other hub computing devices 11. In the example of FIG. 4B, the software container 66b determines that data from (or based on data from) the message 68(2) should be sent to the container 64b and that the message 68(2) should be forwarded, via the mesh network 18, to other hub computing devices 11. The software container 66b generates a common-formatted message 68(6) that includes data, based on the data from on the message 68(2), indicating how a visual display being output via the AR EUD 12b should be modified. If, per the earlier example, the sensor 13a1 is a GPS sensor and the message 68(2) comprises location data indicating a location of the sensor 13a1 (and thus, of the PAN system 10a), an identifier of the sensor 13a1, the topic, the time, and the PAN system identifier of the PAN system 10a, the software container 66b may generate a common-formatted message 68(6) that includes data, based on the update to the operational model of the hub computing device 11b based on the message 68(2), indicating how a visual display being output via the AR EUD 12b should be modified. For example, the visual display being output via the AR EUD 12b may be modified to indicate a position of the PAN system 10a (and thus of an operator corresponding to the PAN system 10a). The software container 66b may send the message 68(6) to the container 64b and forward the message 68(2), via the mesh network 18, to one or more other hub computing devices 11. Based on receiving the message 68(6), the software container 64b may generate a message 68(7) that comprises display data from (or based on) data from the message 68(6), and that will cause the AR EUD 12b to modify a visual display that is being output. The message 68(7) may be in a format, and/or sent via an API, that is unique to the AR EUD 12b.

One or more additional hub computing devices receiving the forwarded message 68(2), or receiving the message 68(2) after further forwarding, may process the message 68(2) in a manner similar to that described above for the hub computing device 11b. However, one or more of those other hub computing devices 11 may determine that the message 68(2) should not be further forwarded. For example, the message 68(2) may comprise a unique message identifier (e.g., added by the software container 63a1 when generating the message 68(2)). A hub computing device receiving the message 68(2) via the mesh network 18 may determine, based on that message identifier, whether that hub computing device has previously received the message 68(2). If the message 68(2) has been previously received, the hub computing device 11 may drop the message 68(2) without further forwarding or processing. Also or alternatively, a hub computing device 11 may use other methods to determine whether a message, received via the mesh network 18, should be further forwarded and/or processed. For example, a time in the message (e.g., a time added as part of the common messaging format) may be examined and messages older than a predetermined amount may be dropped.

A common messaging format used by the hub computing devices 11 may comprise and/or be defined by a plurality of predefined schema that are indicated by a plurality of APIs (e.g., a plurality of rest APIs) associated with the containerization platform 62. Each of the predefined schema may define a particular type of data transfer object with one or more properties, with each of those properties corresponding to a particular category of information being communicated by a message. A schema may specify each of the properties it comprises. The common messaging format may define what values for each of those properties represent, a data type (e.g., string, array, number, Boolean) for values of the property, a format for values (e.g., integer) and/or other characteristics (e.g., whether the property is nullable in a particular schema). Because the same categories of information may be used in multiple types of information, the same properties may be specified for multiple different schema and/or may appear in different combinations in different schema. A common-formatted message may thus comprise, for each of the properties specified by a schema associated with that message, one or more name: value combinations in the order specified by the schema, and which each includes the defined name of the property followed by one or more values (as defined for the property by the common messaging format) or by a null value (if permitted). Table 1 shows definitions for various example properties, each of which may be part of multiple different schema. Table 2 shows definitions for various example schema, as well as properties from Table 1 that may be comprised by those schema.

TABLE 1
Definitions for Example Properties

| Property Name | What Property Value(s) Represent | Data Type |
|---|---|---|
| message | descriptive text associated with a message or | string |
| | portion of a message | |
| udtoTopic | a topic associated with a message | string |
| sourceGuid | a globally unique identifier for a sensor or other | string |
| | device in a system such as the system 1 or a | |
| | portion thereof (e.g., a portion of the system 1 | |
| | comprising the mesh network 18 and all PAN | |
| | systems 10 and other devices communicating via | |
| | the mesh network 18) | |
| timeStamp | a time that a message is created or captured by a | string |
| | hub computing device | |
| panID | an identifier of a hub computing device of a PAN | string |
| | system | |
| lat | a latitude | number (double) |
| lng | a longitude | number (double) |
| alt | an altitude | number (double) |
| toUser | an identifier of a user to whom data in a message | string |
| | (e.g., chat text) is being sent | |
| fromUser | an identifier of a user from whom data in a | string |
| | message (e.g., chat text) is being sent | |
| speed | speed associated with a moving physical object in | number (double) |
| | the operational environment (e.g., a target or | |
| | other object identified in or associated with a | |
| | message) | |
| heading | compass direction associated with a moving | number (double) |
| | physical object in the operational environment | |
| | (e.g., a target or other object identified in or | |
| | associated with a message) | |
| sourceKey | may be the same as sourceGuid | string |
| panKey | may be the same as panID | string |
| position | a position of a physical object in the operational | Value(s) may be |
| | environment | formatted |
| | | according to |
| | | UDTO_Position |
| | | schema |
| chat | a text communication | Value(s) may be |
| | | formatted |
| | | according to |
| | | UDTO_ChatMessage |
| | | schema |
| direction | a direction of movement within the operational | Value(s) may be |
| | environment | formatted |
| | | according to |
| | | UDTO_Direction |
| | | schema |
| topics | identifiers/names of multiple instances of the topic | array |
| | property | |
| units | units associated with values of other properties in | string |
| | a message | |
| width | a width of a physical object in the operational | number (double) |
| | environment | |
| height | a height of a physical object in the operational | number (double) |
| | environment | |
| depth | a depth of a physical object in the operational | number (double) |
| | environment | |
| pinX | an X axis coordinate of a location, in the | number (double) |
| | operational environment, associated with a corner | |
| | or other portion of a bounding box | |
| pinY | a Y axis coordinate of a location, in the | number (double) |
| | operational environment, associated with a corner | |
| | or other portion of a bounding box | |
| pinZ | a Z axis coordinate of a location, in the | number (double) |
| | operational environment, associated with a corner | |
| | or other portion of a bounding box | |
| xLoc | an X axis coordinate of a location in the | number (double) |
| | operational environment | |
| yLoc | a Y axis coordinate of a location in the operational | number (double) |
| | environment | |
| zLoc | a Z axis coordinate of a location in the operational | number (double) |
| | environment | |
| xAng | angular rotation, in the physical environment, | number (double) |
| | about an X axis | |
| yAng | angular rotation, in the physical environment, | number (double) |
| | about a Y axis | |
| zAng | angular rotation, in the physical environment, | number (double) |
| | about a Z axis | |
| bodyName | name/identifier associated with a body (e.g., a | string |
| | physical object in the operational environment) | |
| bodyType | type of physical object associated with a body | string |
| symbol | type of symbol to be used (e.g., in a display | string |
| | output via an AR EUD) to represent a body | |
| platformName | identifier/name for a platform (see additional | string |
| | explanation following Table 2) | |
| data | information relating a body | string |
| position | location of a body or element thereof | Value(s) may be |
| | | formatted |
| | | according to |
| | | UDTO_Position |
| | | schema |
| boundingBox | a defined region in the operational environment | Value may be |
| | | formatted |
| | | according to |
| | | schema |
| | | comprising |
| | | multiple data |
| | | objects (e.g., |
| | | units, width, |
| | | height, depth, |
| | | pinX, pinY, pinZ) |
| uniqueGuid | a globally unique identifier associated with | string |
| | something else in a message | |
| targetGuid | a globally unique identifier associated with a | string |
| | target physical object in the operational | |
| | environment | |
| labelName | a label associated with a body (e.g., a label for | string |
| | use in a display via an AR EUD) | |
| type | generic descriptor/identifier of a type | string |
| text | generic text (e.g., descriptive text) | string |
| bodies | identifiers/names of multiple bodies associated | Value(s) may be |
| | with a UDTO_Platform | formatted |
| | | according to |
| | | UDTO_Body |
| | | schema |
| labels | identifiers/names of multiple labels associated | Value(s) may be |
| | with a UDTO_Platform | formatted |
| | | according to |
| | | UDTO_Label |
| | | schema |
| sources | identifiers/names of multiple sources (e.g., all | Value(s) may be |
| | sources in mesh network) | formatted |
| | | according to |
| | | UDTO_TopicMap |
| | | schema |
| panids | identifiers/names of multiple panIDs (e.g., all hub | Value(s) may be |
| | computing devices in mesh network) | formatted |
| | | according to |
| | | UDTO_TopicMap |
| | | schema |
| platforms | identifiers/names of multiple platforms (e.g., all | Value(s) may be |
| | platforms known by hub computing devices of | formatted |
| | mesh network) | according to |
| | | UDTO_Platform |
| | | schema |
| lastPong | last communication associated with a hub | string |
| | computing device | |
| defaultPanID | default PanID for a hub computing device (e.g., at | \|string |
| | boot time) | |
| defaultSquadID | default identifier for a squad (e.g., grouping of hub | string |
| | computing devices) (e.g., at boot time) | |
| defaultURL | a default URL of a hub computing device (e.g., at | string |
| | boot time) | |
| defaultTileServer | a default server from which map tiles may be | string |
| | downloaded (e.g., at boot time) | |
| defaultDefaultlocation | default map location (e.g., at boot time) | string |
| note | generic text | string |
| range | a distance to a physical object (e.g., a target) in | number (double) |
| | the operational environment | |
| targetHashCode | unique identifier (e.g., for a message) | string |
| command | action for a hub computing device (e.g., for | args |
| | execution for the hub computing device) | |
| args | additional information for a command | array |
| name | a name of a sensor | string |
| active | state of a sensor | string |
| extra | indicator that additional description/information | string |
| | follows | |
| container | an identifier of a software container | string |
| source | may be the same as sourceGuid | string |
| codec | CODEC (coder/decoder) associated with video | string |
| url | network location of external asset | string |
| topic | a string describing a message type (see additional | string |
| | explanation following Table 2) | |
| status | indication of whether an event (e.g., something | Boolean |
| | requested in a message) is successfully | |
| | completed | |
| isConfirmed | indicator of hub computing device presence in | Boolean |
| | mesh network | |
| lastSent | indicator of last message sent by hub computing | string |
| | device | |
| lastReceived | indicator of last message received by hub | string |
| | computing device | |
| autoConnect | indicator of whether hub computing device should | Boolean |
| | automatically search for and/or connect to mesh | |
| | network | |
| isConnected | indicator of whether hub computing is connected | Boolean |
| | to mesh network | |
| countSent | indicator of count of messages sent by hub | integer (int64) |
| | computing device | |
| countReceived | indicator of count of messages received by hub | integer (int64) |
| | computing device | |
| squadKey | an identifier for a squad (e.g., a group of one or | string |
| | more PAN systems 10) | |
| neighbors | indicator/list of other hub computing devices of | array |
| | mesh network | |
| isRunning | indicator that hub computing device is operating | Boolean |
| sensor | indicator of instance of UDTO_Sensor | Value(s) may be |
| | | formatted |
| | | according to |
| | | UDTO_Sensor |
| | | schema |
| sensorTimer | timer associated with confirming sensor is active | Value(s) may be |
| | | formatted |
| | | according to |
| | | Timer schema |

TABLE 2
Definitions for Example Schema

| | Messages/Message Parts For | Properties Comprised |
|---|---|---|
| Schema Name | Which Schema Used | by Schema |
| UDTO_Position | a message used to communicate | udtoTopic, |
| | location information | sourceGuid, |
| | | timeStamp, panID, lat, |
| | | lng, alt |
| UDTO_ChatMessage | a message used to communicate a | udtoTopic, |
| | text message | sourceGuid, |
| | | timeStamp, panID, |
| | | toUser, fromUser, |
| | | message |
| UDTO_Direction | a message used to communicate a | udtoTopic, |
| | direction and speed of travel | sourceGuid, |
| | | timeStamp, panID, |
| | | speed, heading |
| UDTO_TopicMap | list of live topics for a hub computing | sourceKey, panKey, |
| | device | position, chat, |
| | | direction, topics |
| BoundingBox | data associated with three- | units, width, height, |
| | dimensional boundary | depth, pinX, pinY, |
| | | pinZ |
| HighResPosition | data associated with a three- | units, xLoc, yLoc, |
| | dimensional location | zLoc, xAng, yAng, |
| | | zAng |
| UDTO_Body | a message used to communicate | udtoTopic, |
| | data associated with a body | sourceGuid, |
| | | timeStamp, panID, |
| | | uniqueGuid, |
| | | bodyName, |
| | | bodyType, symbol, |
| | | platformName, data, |
| | | position, boundingBox |
| UDTO_Label | a message used to communicate a | udtoTopic, |
| | label associated with a platform | sourceGuid, |
| | | timeStamp, panID, |
| | | uniqueGuid, |
| | | targetGuid, |
| | | labelName, type, text, |
| | | platformName, data, |
| | | position |
| UDTO_Platform | a message used to communicate | udtoTopic, |
| | data associated with a platform | sourceGuid, |
| | | timeStamp, panID, |
| | | platformName, |
| | | position, |
| | | boundingBox, bodies, |
| | | labels |
| UDTO_Relation | a message used to communicate | (e.g., properties |
| | data associated with relationship | associated with |
| | between bodies of a platform (e.g., | related bodies) |
| | part/subpart, positional relationship, | |
| | etc.) | |
| UDTO_CentralModel | a message used to forward all central | sources, panids, |
| | model data from a hub computing | platforms, lastPong, |
| | device | defaultSquadID, |
| | | defaultURL, |
| | | defaultTileServer, |
| | | defaultDefaultLocation |
| UDTO_Objective | a message used to communicate | udtoTopic, |
| | data associated with a mission | sourceGuid, |
| | objective | timeStamp, panID, lat, |
| | | lng, alt, uniqueGuid, |
| | | name, type, symbol, |
| | | note |
| UDTO_Observation | a message used to communicate | udtoTopic, |
| | data associated with a mission | sourceGuid, |
| | observation | timeStamp, panID, lat, |
| | | lng, alt, uniqueGuid, |
| | | target, range |
| UDTO_Command | a message used to communicate | udtoTopic, |
| | commands between hub computing | sourceGuid, |
| | device | timeStamp, panID, |
| | | targetHashCode, |
| | | command, args |
| UDTO_Sensor | a message used to communicate | udtoTopic, |
| | data associated with attaching a | sourceGuid, |
| | sensor to hub computing device | timeStamp, panID, |
| | | type, name, active, |
| | | extra, container, |
| | | source |
| UDTO_Camera | a message used to communicate | udtoTopic, |
| | data associated with attaching a | sourceGuid, |
| | camera sensor to hub computing | timeStamp, panID, |
| | device | attributes, name, |
| | | active, codec, url |
| SquireMeshNode | a message used to communicate | panKey, url, note, |
| | data describing structure of mesh | isConfirmed, lastSent, |
| | network | lastReceived, |
| | | autoConnect, |
| | | isConnected, |
| | | countSent, |
| | | countReceived, |
| | | squadKey, |
| | | defaultLocation, |
| | | tileServer |
| SquireLink | a message used to communicate | |
| | data describing structure of mesh | |
| | network | |
| SquireConnector | a message used to communicate | isRunning, sensor, |
| | data describing structure of mesh | sensorTimer |
| | network | |
| HighResOffset | data associated with a three- | units, xLoc, yLoc, |
| | dimensional location of a platform | zLoc, xAng, yAng, |
| | (e.g., offset based on geographic | zAng |
| | location) | |

As indicated in Table 1, a value of the platformName property may represent an identifier/name for a platform. A platform may correspond to a layout (e.g., positions of boundary points) for a group of multiple bodies (e.g., a building, truck, ship, etc.) in the operational environment. Multiple bodies may be grouped by associating a platform name with each of those bodies. Each hub computing device 11 may maintain, over time, a point-of-view (POV) data model that allows viewing data for those bodies (e.g., locations, boundaries) collectively and from various from the perspectives. The POV data model may be based on, and may group data from, UDTO_Platform, UDTO_Body, UDTO_Label, and UDTO_Relation messages. POV messages (e.g., UDTO_Platform, UDTO_Body, UDTO_Label, UDTO_Relation) may carry common data that may be aggregated to create a three dimensional POV model.

As indicated in Table 1, a value of the topic property may be a string describing a message type. The topic may allow decoding of a message containing the topic, and/or forwarding of that message without decoding. A topic may act as a label to indicate what data has been added to a message and where the message should be routed (e.g., which container) for processing.

Tables 1 and 2 are merely examples. Additional properties and/or messages may be defined. For example, additional topics may be defined by creating strings that indicate those additional topics and by creating corresponding instructions for routing and processing messages that include those strings.

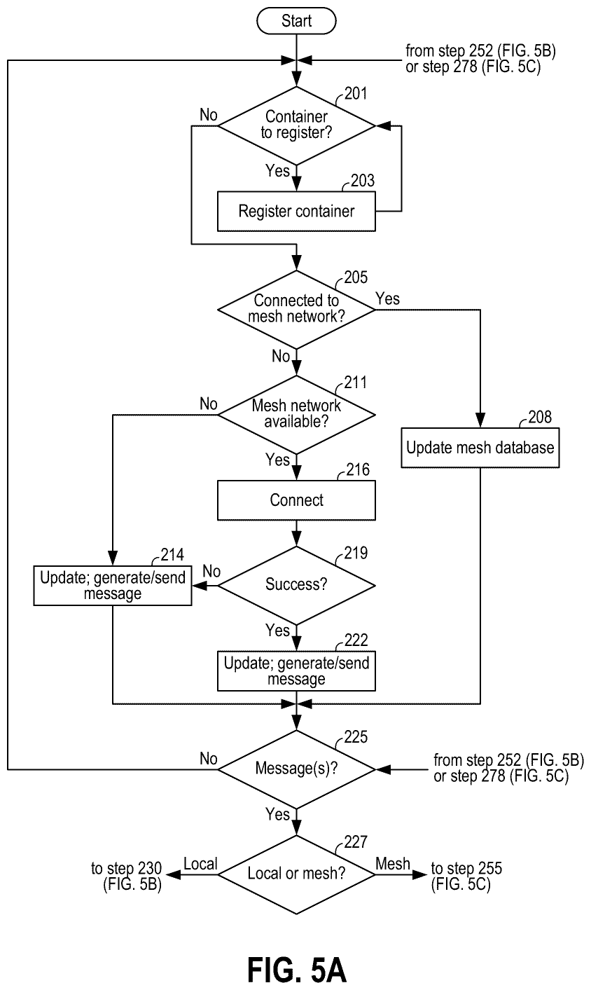

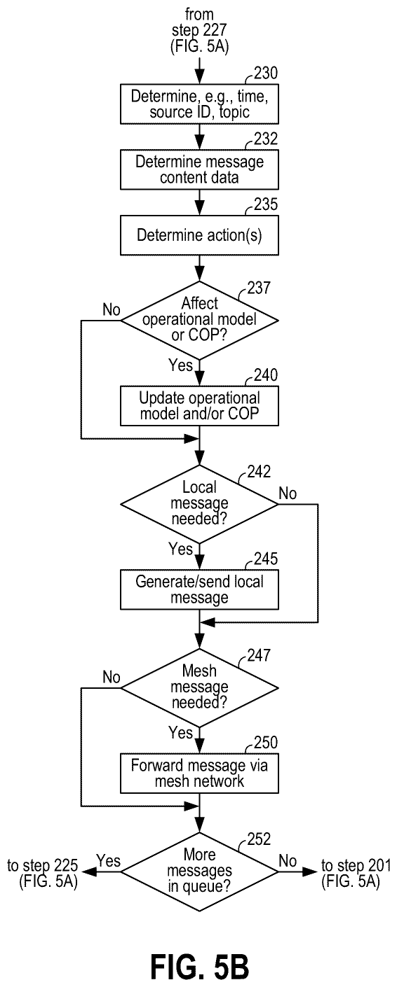

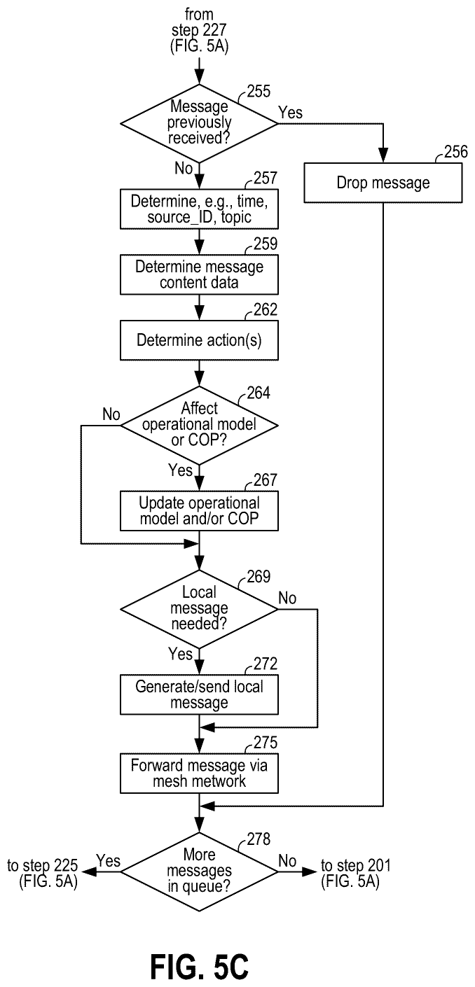

FIGS. 5A, 5B, and 5C are a flow chart showing steps of an example method that may be performed by a PAN system controller software container 66 of a hub computing device 11 of a PAN system 10. For convenience, FIGS. 5A through 5C are described below using the example of the PAN system controller software container 66a of the hub computing device 11a of a PAN system 10a. However, steps similar to those of FIGS. 5A through 5C may also or alternatively be performed by other software containers 66 of other hub computing devices 11 of other PAN systems 10. The steps of FIGS. 5A through 5C may be performed in other orders and/or may otherwise be modified. One or more of the steps of FIGS. 5A through 5C may be omitted, and/or other steps may be added. Instead of a single software container performing the steps of FIGS. 5A through 5C, one or more steps (or portions thereof) may be performed by one or more other software containers (e.g., the functions of the software container 66a may be divided among multiple software containers).

In step 201, the software container 66a may determine whether there are any software containers, in addition to the software container 66a, to be registered. As indicated above, software containers may be created at runtime based on container image files, stored in a container registry, that comprise read-only templates defining applications and dependencies of software containers. A containerization platform 62 of a hub computing device 11 may be configured to first create a PAN system controller software container 66 from its corresponding container image file, and to subsequently create the other software containers 63, 64, and 65 from corresponding container image files stored in the container registry. As each software container 63, 64, or 65 is created by a hub computing device 11, that software container may register with the PAN system controller software container 66 of that hub computing device 11. As each software container 63, 64, or 65 registers, it may identify itself to the software container 66 and inform the software container 66 of the type(s) of data that it may output and/or of the topic(s) that may be associated those data type(s). The registering container may also or alternatively inform the software container 66 of the type(s) of data that it may receive and/or of the topics that may be associated with such data type(s).

If the software container 66a determines in step 201 that there is a container to register, the software container 66a performs step 203. In step 203, the software container 66a registers the software container. If there are multiple software containers to be registered, the software container 66a may perform step 203 with regard to the next software container in a queue of software containers to be registered. As part of step 203, the software container 66a may store, in a table or other database structure, an identifier of the registering software container, a type of sensor associated with the registering software container (e.g., if the software container is associated with a sensor), a type of data processing that may be performed by the software container (e.g., if the is a container 65), the type(s) of data (and associated topic(s)) that may be output by the registering software container, the type(s) of data (and associated topic(s)) that may be sent to the registering software container, and/or other information. After performing step 203, the software container 66a may repeat step 201. If the software container 66a determines in step 201 that there are no more software containers to register, step 205 may be performed. For convenience, other software containers on the same hub computing device 11a (e.g., the software containers 63a, 64a, and 65a, relative to the software container 66a) may be referred to below as “local software containers.”

In step 205, the software container 66a may determine if the hub computing device 11a is connected to the mesh network 18. The software container 66a may track the mesh network 18 as a logical concept that may cross infrastructure boundaries and/or that may be configured and/or reconfigured (independent of the software container 66a) to use any of multiple potential communication paths and corresponding physical interfaces. For example, lower level software components (e.g., of the operating system 11a) may be configured to select (e.g., based on availability) from multiple physical interfaces via which network connectivity may be established, to establish connectivity via one or more (e.g., for multipath communications) selected physical interfaces, to maintain one or more connections, and to present a logical interface to the software container 66a via which communications with other hub computing devices 11 (and/or other devices) may be carried out. If the software container 66a determines in step 205 that the hub computing device 11a is connected to the mesh network 18, the software container 66a may in step 208 update a mesh database comprising a table or other database structure that identifies other hub computing devices 11 that are currently connected to the mesh network 18. After step 208, the software container 66a may perform step 225, which is described below. If the software container 66a determines in step 205 that the hub computing device 11a is not connected to the mesh network 18, the software container 66a may perform step 211.

In step 211, the software container 66a may determine if the mesh network 18 is available. For example, the software container 66a may determine if the above-mentioned logical interface associated with the mesh network is available. Also or alternatively, the software container 66a and/or lower level software components (e.g., of the operating system 11a) may determine whether a signal strength, associated with physical interface via which connectivity to the mesh network 18 is to be established, satisfies a threshold level, whether signals from other hub computing devices 18 are detectable, etc. If the software container 66a determines in step 211 that the mesh network 18 is not available, the software container 66a may in step 214 update the mesh database and/or one or more other databases, and/or the operational model maintained for the PAN system 10a by the software container 66a (hereafter “PAN system 10a operational model”), to indicate that mesh network connectivity is lost. As part of step 214, the software container 66a may generate one or more commonly-formatted messages and send those one or more messages to one or more local software containers. For example, the software container 66a may send a commonly-formatted message to the software container 64a that indicates mesh connectivity is lost, and that causes the software container 64a to modify (via a message such as the message 68(5)) a display of the AR EUD 12a to indicate no mesh connectivity. After step 214, the software container 66a may perform step 225.

If the software container 66a determines in step 211 that connectivity to the mesh network 18 is available, the software container 66a may in step 216 attempt to connect to the mesh network 18. If the software container 66a determines in step 219 that the connection attempt was not successful, step 214 may be performed. If the software container 66a determines in step 219 that the connection attempt was successful, step 222 may be performed. In step 222, the software container 66a may update the mesh database and/or the PAN system 10a operational model to indicate connection to the mesh network 18 and/or other hub computing devices 11 connected to the mesh network 18. The software container 66a may also generate and send one or more commonly-formatted messages to one or more local software containers. For example, such a commonly-formatted message may cause the software container 64a to modify a display to indicate mesh network connection.

After step 222, the software container 66a may in step 225 determine whether it has received any commonly-formatted messages from a local container (e.g., a message such as the message 68(2) of FIG. 4A) or via the mesh network 18 (e.g., a message such as the message 68(2) of FIG. 4B). If no, the software container 66a may perform step 201. If yes, the software container 66a may determine if a selected message (e.g., a single received message, if only one message has been received, or a next message in a queue of received messages, if there are multiple received messages to be processed) was received from a local software container or via the mesh network 18. The software container 66a may make the determination of step 227 based on a PAN ID (panID or panKey in Table 1) in the selected message. A PAN ID associated with the hub computing device 11a and/or PAN system 10a may indicate that the selected message is from a local software container. A PAN ID not associated with the hub computing device 11a or the PAN system 10a (e.g., a PAN ID of another hub computing device 11 or PAN system 10, or an ID associated with a sensor 14 or 15) may indicate that the selected message was received via the mesh network 18. If the selected message was received from a local software container, the software container 66a may perform step 230 (FIG. 5B).

In step 230, the software container 66a may determine data from the selected message that will indicate how other data in the selected message should be processed and/or what steps should be taken with regard to that other data. The information determined in step 230 may comprise, for example, a time stamp of the selected message, a source ID (e.g., an identifier of a sensor), and/or a topic associated with the selected message.

Software containers 66 in the system 1 (FIG. 1) may store data defining topics associated with sensors, with types of data, and/or with elements of a Common Operational Picture (COP). A COP may represent a management of view of an operational environment, and may comprise numerous data elements. Examples of data elements of a COP may comprise: location of an operator, a PAN system associated with an operator, status (e.g., health) of an operator, whether communications with an operator (e.g., connection to the mesh network 18) are available, locations of other persons (e.g., enemy personnel) in the operational environment, locations of physical objects (e.g., building, roads, vehicles, equipment, obstacles) in the operational environment, objectives of one or more of the operators, regions in the operational environment, physical conditions (e.g., fire, heat, rain, snow, cold, etc.) in the operational environment, routes in the operational environment, etc.

In step 232, the software container 66a may determine data in the selected message that is to be processed (e.g., to update the COP and/or the PAN system 10a operational model, to generate an output to an operator, to control a sensor and/or output device of the PAN system 10a, etc.). Such data may comprise, for example, position data associated with an operator, position data associated with another person (or persons), position data associated with a physical object in the operational environment, status information regarding an operator or other person, a route in the operational environment, information about a target or other objective in the operational environment, image data, video data, audio data, text data (e.g., a chat message), or any other type of data.

In step 235, the software container 66a may determine, based on data determined in step 230 and/or in step 232, actions to be taken based on the selected message. Such actions may, for example, comprise updating the COP and/or the PAN system 10a operational model. Such actions may, for example, also or alternatively comprise generating and sending a commonly-formatted message to one or more local software containers that causes each of the those software containers to cause and/or modify output of a display via corresponding sensor(s) or other device(s) (e.g., an AR EUD 12 or other output device). Such actions may, for example, also or alternatively comprise generating and sending a commonly-formatted message to one or more local software containers to cause other modifications to operation of corresponding sensor(s) or other devices (e.g., to change a reporting rate of a sensor, to query the sensor for output, etc.). Such actions may, for example, also or alternatively comprise generating and sending a commonly-formatted message to one or more local software containers to cause a communication (e.g., a textual chat message, a voice message, an image, a video) to be output to an operator. Such actions may, for example, also or alternatively comprise generating and sending a commonly-formatted message to upload data (e.g., data from the selected message and/or from one or more previously selected messages) to the CP system 19 or to download data (e.g., map tiles, data regarding targets and other objectives) from the CP system 19. Such actions may, for example, also or alternatively comprise generating and sending a commonly-formatted message to a software container (e.g., one of the software containers 65a through 65n) to perform additional processing of data in the selected message. Such actions may, for example, also or alternatively comprise forwarding the selected message (or a new message generated based on the selected message), via the mesh network 18, to other hub computing devices 11. Numerous other actions may be determined based on data determined in step 230 and/or in step 232.

In step 237, the software container 66a may determine if the actions determined in step 235 comprise updating the PAN system 10a operational model or the COP. If no, step 242 (described below) may be performed. If yes, the software container 66a may in step 240 update the PAN system 10a operational model and/or the COP based on data determined in step 230 and/or in step 232. As part of step 240, the software container 66a may update a message history database based on the selected message. The message history database may comprise a table or other database structure that comprises data from (or based on) some or all messages received by the software container 66a during some predefined period (e.g., a period of time associated with operations being conducted in the operational environment). For each message in the message history database, a record may comprise one or more topics associated with the message, a time of the message, a PAN ID of the PAN system 10 where the message originated, a source ID of a sensor associated with the message, data from the message (e.g., data determined in step 232), data generated (e.g., by the software container 66a) based on the message, and or other data. Data from a message may be added to appropriate fields in the message history database based on identification of data, according to the common messaging format, in the message. Data from the message history database may be uploaded to the CP system 19 (e.g., to allow tracking of operators associated with PAN systems 10, etc.). After step 240, the software container 66a may perform step 242.

In step 242, the software container 66a may determine if the actions determined in step 235 comprise generating and sending a message to one or more local software containers. If no, step 247 (described below) may be performed. If yes, the software container 66a may in step 245 generate and send one or more commonly-formatted messages to one or more local software containers. After step 245, the software container 66a may perform step 247.

In step 247, the software container 66a may determine if the actions determined in step 235 comprise generating and sending a message via the mesh network 18 to one or more other hub computing devices 11. If no, step 252 (described below) may be performed. If yes, the software container 66a may in step 250 forward the selected message (or a new commonly-formatted message generated based on the selected message) via the mesh network 18 to one or more other hub computing devices 11. In step 252, the software container 66a may determine if there are other received messages (e.g., in a queue of received messages) awaiting processing by the software container 66a. If yes, step 225 (FIG. 5A) may be performed. If no, step 201 (FIG. 5A) may be performed.

If the software container 66a determines in step 227 (FIG. 5A) that the selected message was received via the mesh network 18, step 255 (FIG. 5C) may be performed. In step 5C, the software container 66a may determine (e.g., based on a unique identifier in the selected message) whether the selected message has previously been received by the hub computing device 11a. If yes, the selected message may be dropped in step 256, as the selected message need not be processed again or forwarded. After step 256, step 278 may be performed. If the software container 66a determines in step 255 that the selected message was not previously received, step 257 may be performed.

In step 257, which may be similar to step 230, the software container 66a may determine data from the selected message that will indicate how other data in the selected message should be processed and/or what steps should be taken with regard to that other data. As part of step 257, and similar to step 240, the software container 66a may update a message history database based on the selected message. In step 259, which may be similar to step 232, the software container 66a may determine data in the selected message that is to be processed. In step 262, which may be similar to step 235, the software container 66a may determine, based on data determined in step 257 and/or in step 259, actions to be taken based on the selected message. In step 264, which may be similar to step 237, the software container 66a may determine if the actions determined in step 262 comprise updating the PAN system 10a operational model or the COP. If no, step 269 (described below) may be performed. If yes, the software container 66a may in step 267 update the PAN system 10a operational model and/or the COP based on data determined in step 257 and/or in step 259. After step 267, the software container 66a may perform step 269.

In step 269, which may be similar to step 242, the software container 66a may determine if the actions determined in step 262 comprise generating and sending a message to one or more local software containers. If no, step 275 (described below) may be performed. If yes, the software container 66a may in step 272 generate and send one or more commonly-formatted messages to one or more local software containers. After step 272, the software container 66a may in step 275 forward the selected message via the mesh network 18. In step 278, which may be similar to step 252, the software container 66a may determine if there are other received messages (e.g., in a queue of received messages) awaiting processing by the software container 66a. If yes, step 225 (FIG. 5A) may be performed. If no, step 201 (FIG. 5A) may be performed.

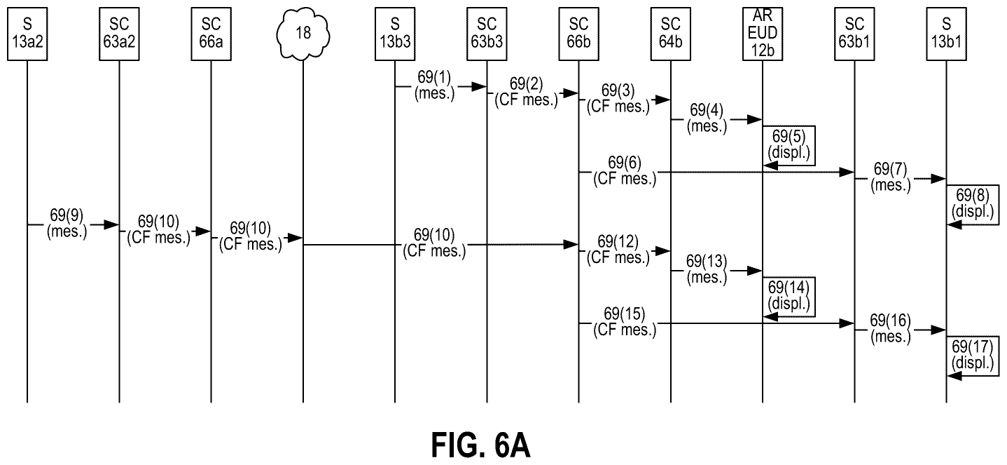

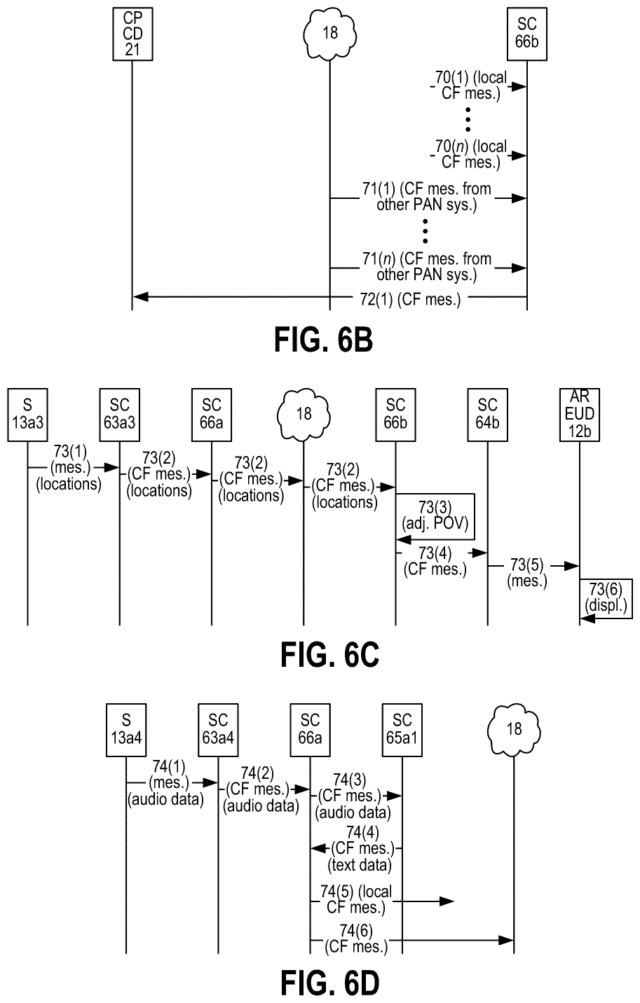

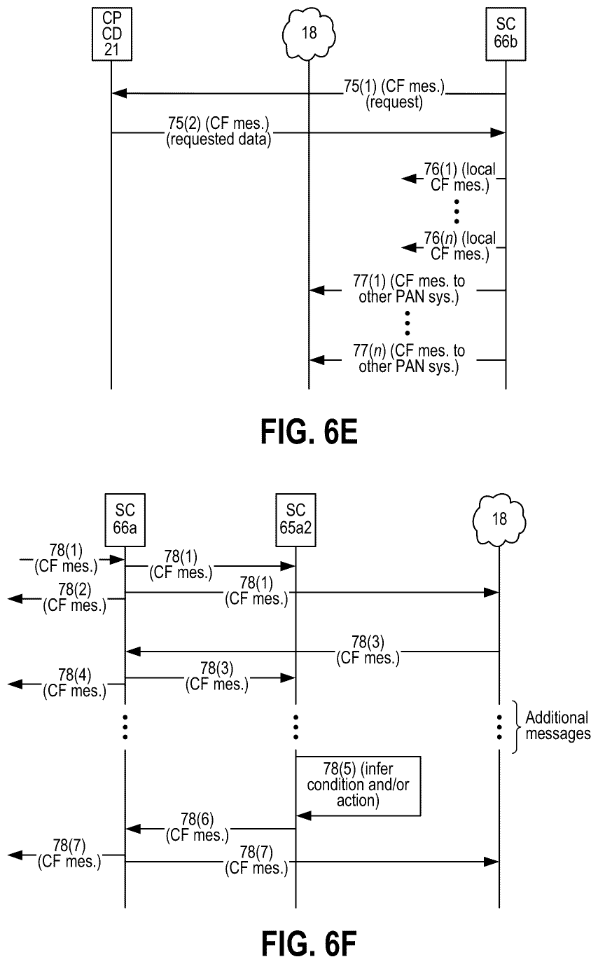

FIGS. 6A through 6E are communication flow diagrams that show several non-limiting examples of how data may be shared between software containers within the same hub computing device 11 and/or between software containers of different hub computing devices 11. In the example of FIG. 6A, the software container 63b3 corresponding to the sensor 13b3 may receive a message 69(1) from the sensor 13b3 comprising sensor data. Based on the message 69(1), the software container 63b3 may generate and send a commonly-formatted message 69(2) to the software container 66b. The message 69(2) may comprise sensor data from the message 69(1) and/or data generated by the software container 63b3 based on the sensor data from the message 69(1). Based on the message 69(2), the software container 66b may generate and send a commonly-formatted message 69(3) to the software container 64b. The message 69(3) may comprise data from the message 69(2) and/or data generated by the software container 66b based on data from the message 69(2). Based on the message 69(3), the software container 64b may generate and send a message 69(4) to the AR EUD 12b. The message 69(4) may, in operation 69(5), cause the AR EUD 12b to output and/or modify a display.

The software container 66b may also generate and send, based on the message 69(2), a commonly-formatted message 69(6) to a software container 63b1 corresponding to the sensor 13b1. The message 69(6) may comprise data from the message 69(2) and/or data generated by the software container 66b based on data from the message 69(2). The message 69(6) may be the same as the message 69(3). Based on the message 69(6), the software container 63b1 may generate and send a message 69(7) to the sensor 13b1. As shown in FIG. 2, the sensor 13b1 may comprise a user input device that is also able to generate a visual display to output information. The message 69(7) may, in operation 69(8), cause the sensor 13b1 to output and/or modify a display.

As also shown in FIG. 6A, the software container 63a2 (of the hub computing device 11a) corresponding to the sensor 13a1 may receive a message 69(9) comprising sensor data. Based on the message 69(9), the software container 63a1 may generate and send a commonly-formatted message 69(10) to the software container 66a. The message 69(10) may comprise sensor data from the message 69(9) and/or data generated by the software container 63a1 based on the sensor data from the message 69(9). Although not shown in FIG. 6A, the software container 66a may, based on the message 69(1), generate and send one or more messages (e.g., similar to the messages 69(3) and 69(6)) to one or more local software containers, which message(es) may cause the local software container(s) to generate messages (e.g., similar to the messages 69(4) and 69(7)) that cause output of and/or modification of displays (e.g., via the AR EUD 12a and/or one or more sensors 13a).

As is shown in FIG. 6A, the software container 66a may, based on the message 69(10), forward the message 69(10) via the mesh network 18. The message 69(10) may be received by the software container 66b. Based on the message 69(10), the software container 66b may generate and send a commonly-formatted message 69(12) to the software container 64b. The message 69(12) may comprise data from the message 69(10) and/or data generated by the software container 66b based on data from the message 69(10). Based on the message 69(12), the software container 64b may generate and send a message 69(13) to the AR EUD 12b. The message 69(13) may cause, in operation 69(14), the AR EUD to output and/or modify a display. The software container 66b may also generate and send, based on the message 69(10), a commonly-formatted message 69(15) to the software container 63b1. The message 69(15) may comprise data from the message 69(10) and/or data generated by the software container 66b based on data from the message 69(10). The message 69(15) may be the same as the message 69(12). Based on the message 69(15), the software container 63b1 may generate and send a message 69(16) to the sensor 13b1. The message 69(16) may, in operation 69(17), cause the sensor 13b1 to output and/or modify a display.

The message 69(10) may also be received, via the mesh network 18, by other software containers 66 of other hub computing devices. The other software containers 66 may process the message 69(10) in a manner similar to that shown for the software container 66b, which may in turn cause further messages (e.g., similar to the messages 69(13) and/or 69(16) that cause output of and/or modification of displays). Although FIG. 6A shows message 69(9) occurring after operation 69(8), this need not be the case. For example, the message 69(9) may occur before the message 69(1), or may occur after the message 69(1) and before the operation 69(8). The sensor 13a2 and the software container 63a2 may be similar to the sensor 13b3 and the software container 63b3, respectively, but this need not be the case. For example, the sensor 13a2 may be of a type completely different from the sensor 63b3, and the software container 63a2 may be different from the software container 63b3. The sensor 13a2 may be a type of sensor that the PAN system 10b lacks, and the PAN system may lack a software container similar to the software container 63a2.

In the example of FIG. 6B, the software container 66b may receive multiple commonly-formatted messages 70(1) through 70(n) from one or more local software containers corresponding to one or more sensors of the PAN system 10b. Based on each of the messages 70(1) through 70(n), the software container 66b may update a message history database, as described in connection with step 240 of FIG. 5B. The software container 66b may also receive, via the mesh network 18, multiple commonly-formatted messages 71(1) through 70(n) from one or more software containers 66 of one or more other PAN systems 10. Based on each of the messages 71(1) through 71(n), the software container 66b may update the message history database, as described in connection with step 257 of FIG. 5C. After the receiving the messages 70(1) through 70(n) and 71(1) through 71(n) and updating the message history database, the software container 66b may send (e.g., via the mesh network 18 or via another communication path (e.g., the RF link 17)) one of more messages 72(1) to the CP computing device 21. The message(s) 72(1) may comprise data from the message history database. Message(s) such as the message(s) 72(1) may be sent at predefined intervals, based on a request, and/or on some other basis. The CP computing device 21 may store data from the message(s) 72(1) in the database 22, may upload such data to the server(s) 27, and/or may use such data to, for example, generate displays showing the COP or portions thereof, positions and/or statuses of operators, and/or other information.

In the example of FIG. 6C, a software container 63a3 corresponding to a sensor 13a3 may receive a message 73(1) from the sensor 13a3. The message 73(1) may comprise data indicating one or more locations. For example, the data may indicate one or more locations that were input by a user and that correspond to some physical object in the operational environment (e.g., a target or other objective), to some region in the operational environment (e.g., a region occupied by a fence, minefield, or other obstruction), or to some other feature of the operational environment. Based on the message 73(1), the software container 63a3 may generate and send a commonly-formatted message 73(2) to the software container 66a. The message 73(2) may contain the location data from the message 73(1) and/or data based on the location data from the message 73(1). Based on the message 73(2), the software container 66a may forward the message 73(2) via the mesh network 18. Based on the message 73(2), and although not shown in FIG. 6C, the software container 66a may also send commonly-formatted messages to local software containers (e.g., to cause output of and/or modification of one or more displays) and/or perform other operations described herein.

The software container 66b, based on receiving the message 73(2), may adjust/translate data from the message 73(2) to another POV as part of operation 73(3). As explained above, each hub computing device 11 may maintain, overtime, a POV data model that allows viewing, from various from perspectives, data relating to physical elements in the operational environment. Data for such elements may be output, via an AR EUD 12 and/or other device (e.g., a tablet such as the sensor 13b1, a smart watch such as the sensor 13b4). Such data may be output, for example, as labels, graphics (e.g., symbols, wireframe lines, colored shading, etc.), images and/or video (e.g., inset into a portion of a display view), and/or other visual elements that correspond to physical elements in the operational environment, and that are located in regions of a display based on a selected POV and on the locations of the physical elements in the operational environment. A POV may comprise a POV of the AR EUD 11 via which the display is being output, a POV of another AR EUD 11 associated with another PAN system 10 (e.g., associated with a different squad member), a POV associated with a target object or position, an aerial/overhead POV, and/or any other arbitrarily selected POV. To determine positions in a display for visual elements corresponding to physical elements in the operational environment, positional data (e.g., latitude and longitude data) for those physical elements may be extracted from messages relating to those elements and may be geometrically translated (e.g., as part of step 245 (FIG. 5B) or step 272 (FIG. 5C)) based on the selected POV. The software container 66b may generate and send (also, e.g., as part of step 245 (FIG. 5B) or step 272 (FIG. 5C)) a message 73(4) comprising the translated positional data, as well as other data associated with the desired visual display (e.g., text, graphical data, etc. corresponding to physical elements in the operational environment). Based on the message 73(4), the software container 64b may generate a message 73(5) and send the message 73(5) to the AR EUD 12b. The message 73(5) may, at operation 73(6), cause the AR EUD 12b to output and/or a modify a display to show one or more display elements corresponding to locations indicated by the location data of the message 73(1). Other software containers 66 of other hub computing devices 11 may process the message 73(2) in a manner similar to that of the hub computing device 66b.

In the example of FIG. 6D, a software container 63a4 corresponding to a sensor 13a4 may receive a message 74(1) from the sensor 13a4. The sensor 13a4 may comprise a microphone, and the message 74(1) may comprise audio data representing speech by an operator associated with the PAN system 10a. Based on the message 74(1), the software container 63a4 may generate and send a commonly-formatted message 74(2) (comprising the audio data from the message 74(1) and or data based on that audio data) to the software container 66a. Based on the message 74(2), the software container 66a may send a commonly-formatted message 74(3), containing data from the message 74(2), to the software container 65a1. The software container 65a1 may comprise one or more speech recognition applications. Based on the message 74(3), the software container 65a1 may perform speech recognition on data received in the message 74(3). The software container 65(1 may generate and send a commonly-formatted message 74(4), comprising text data generated from the speech recognition, to the software container 66a. Based on the message 74(4), the software container 66a may generate and send one or more commonly-formatted messages 74(5) to one or more local software containers, and/or may generate and send, via the mesh network 18, one or more commonly-formatted messages 74(6) (and/or may forward the message 74(4)) to one or more software containers 66 of one or more other hub computing devices 11. If the text data in the message 74(4) comprises a chat message, the message(s) 74(5) may cause local software containers to cause output of the chat message, and the message(s) 74(6) (or forwarded messages 74(4)) may cause software containers 66 of other hub computing devices to generate commonly-formatted messages leading to such output. If the text data in the message 74(4) comprises a command, the message(s) 74(5) may cause local software containers to implement the command and the message(s) 74(6) (or forwarded messages 74(4)) may cause software containers 66 of other hub computing devices to send additional messages to cause implementation of the command.

In the example of FIG. 6E, the software container 66b may generate and send (e.g., via the mesh network 18 and/or via another path) a commonly-formatted message 75(1) to the CP computing device 21 requesting data (e.g., one or more map tiles). The CP computing device 21 may, based on the message 75(1), generate and send one or more commonly-formatted messages 75(2) that supply the data requested by the message 75(1). Based on receiving the message(s) 75(2), the software container 66b may generate and send, to one or more local software containers, one or more messages 76(1) through 76(n) forwarding some or all of the data received in the message(s) 75(2). Based on receiving the message(s) 75(2), the software container 66b may generate and send, via the mesh network 18 and to one or more software containers 66 of one or more other hub computing devices 11, one or more messages 77(1) through 77(n) forwarding some or all of the data received in the message(s) 75(2).

FIG. 6F shows an example in which a software container 65a2 may receive messages and, based on data in those messages, infer a condition and/or an appropriate action. For example, the software container 65a2 may infer, based on data indicating that a relative distance between two objects (e.g., a hostile force and a PAN system 10, a target and a PAN system 10, a PAN system 10 and an objective, etc.) is decreasing, an action that comprises outputting a message comprising a warning and/or a command (e.g., to cause a output of a display of the warning, to send one or more text messages, to cause an actuator of a sensor to fire a weapon and/or activate some other device, etc.). As another example, the software container 65a2 may infer, based on data indicating that an object has been identified, an action that comprises outputting a message comprising a warning and/or command.

In the example of FIG. 6F, the software container 66a may receive message 78(1) from a local sensor, and may forward that message locally to the software container 65a2 and via the mesh network 18 to other hub computing devices 11. The software container 66a may also generate and send one or more local messages 78(2) based on the message 78(1). The software container may also or alternatively receive, via the mesh network 18, a message 78(3) from another hub computing device 11. The software container 66a may forward the message 78(3) locally to the software container 65a2, and may also generate and send one or more local messages 78(4) based on the message 78(3). The software container 66a may receive additional local messages and/or additional messages via the mesh network 18, may forward those additional messages to the software container 65a2, and may take further actions (e.g., forwarding, generating additional messages) regarding those additional messages. In operation 78(5), the software container 65a2 may infer a condition and/or an appropriate action based on the messages 78(1) and 78(3) and on the additional messages forwarded to the software container 65a2. Based on the inferred condition and/or action, the software container 65a2 may generate and send a message 78(6). Based on the message 78(6), the software container 66a may generate and send a message 78(7). The message 78(7) may, for example, cause output of displays (e.g., AR EUDs 12) and/or other actions.

Deploying multiple PAN systems 10 in an operational environment, with each of the PAN systems 10 corresponding to a different individual (operator) carrying out and/or facilitating operations in the operational environment to achieve one or more objectives, offers numerous advantages. Some or all sensors associated with each individual's PAN system 10 may be configured to periodically output updated sensor data. The updated sensor data (or information based on that updated sensor data) may be shared via the mesh network 18 with other PAN systems 10, thereby allowing rapid sharing of information and facilitating each of the individuals having an updated view of the COP. Moreover, each of the individuals is able, via the individual's corresponding PAN system 10, to update the COP shared by all PAN systems. This allows the individuals to have an updated COP without reliance on a connection to a command post or other facility that may be remote from the operational environment. Moreover, use of the mesh network 10 to share information among PAN systems 10, combined with periodic updating of sensor data, allows PAN systems 10 to be self-healing. If a PAN system 10 loses connectivity to the mesh network 18 (e.g., because of temporarily moving out of range), upon reconnection that PAN system 10 will receive updated data from other PAN systems 10 that refreshes the COP for that PAN system 10. Even while disconnected from the mesh network, however, that PAN system 10 will still operate based on data from its own sensors and other data (e.g., map data, mission objective data stored before mesh network connectivity is lost, etc.) stored by the hub computing device 11 of that PAN system 10.

The common messaging format allows simplified communications with multiple types of sensors and between hub computing devices 11, as well as more efficient processing of data from sensors. All messages from (or relating to) a sensor may comprise four data elements that allow rapid classification of data in the message and a determination a PAN system 10 to which the data in the message relates: a PAN ID (panID or panKey in Table 1), a topic (topic in Table 1), a time stamp (timeStamp in Table 1), and a source ID (sourceGuid or sourceKey in Table 1). A PAN ID may comprise a unique identifier of a hub computing device 11. The PAN ID in a commonly-formatted message may be the PAN ID of the PAN system 10 that comprises a sensor generating sensor data associated with that message, thereby facilitating a rapid determination of the PAN system 10 (and the corresponding operator) to which data from the sensor relates. A topic may comprise a label/descriptor indicating additional data in the message and/or indicating where (e.g., to which software container) the message should be routed for processing. Including predefined topics in messages may facilitate processing of data at the edge (e.g., in a hub computing device 11 vs. at a remote computing device such as the CP computing device 21), as well rapid determinations of how sensor data should be routed and/or processed and how the COP may be affected by the sensor data. A time stamp, which allows a determination of whether sensor data (and/or other data in a message) is current, may be a time that a message was created or captured by a software container of a hub computing device 11 and/or the time that the message enters the mesh network 18. Time clocks of multiple hub computing devices 11 need not be synchronized, as the time stamps in messages generated by a particular hub computing device 11 may be used to determine message sequence and uniqueness of messages associated with that hub computing device 11. A source ID, which may a globally unique identifier for a sensor, may further allow rapid determination of an individual sensor associated with a message.

Use of software containers as described herein also offers numerous benefits. For example, manufacturers of sensors, output devices, and other components, as well as developers of software applications that may be used in a hub computing device 11, may create a software container that may be deployed on any type of hub computing device 11 hardware. As another example, software deployment on hub computing devices may be simplified. For example, software stored in memory of a hub computing device 11 may be simplified and limited to containers associated with sensors and other devices of the PAN system 10 comprising that hub computing device 11, software containers associated with applications that may be needed by that hub computing device 11, and a software container associated with a PAN system controller. As another example, simulation of a system of multiple PAN systems 10 is readily achieved. Simulation software containers, which may be similar to actual software containers but configured generate simulated sensor data, may be instantiated and grouped (e.g., with PAN system controller software containers) to simulate separate hub computing devices 11. Connections between the PAN system controller software containers of the groups may be established to simulate various mesh network configurations. In a simulation, time needed for simulated commonly-formatted messages to be forwarded throughout the simulated mesh network may be measured to determine, for example, whether various combinations of software containers in various PAN systems 10 will operate satisfactorily.

As previously indicated, systems such as the system 1 may be used in a wide variety of operational environments. Other examples of operational environments in which the system 1 and/or the PAN systems 10 may be used comprise firefighting (e.g., a plurality of deployed firefighters may each be equipped with a PAN system 10), cargo handling (e.g., a plurality of cargo loaders may each be equipped with a PAN system 10), inventory (e.g., a plurality of inventory personnel may each be equipped with a PAN system 10), law enforcement (e.g., a plurality of police officers may each be equipped with a PAN system 10), health care (e.g., a plurality of doctors, nurses, and/or other health care professionals may each be equipped with a PAN system 10), agriculture/livestock management (e.g., a plurality of agricultural personnel may each be equipped with a PAN system 10), transportation (e.g., a plurality of vehicle operators, dispatchers, maintainers, etc. may each be equipped with a PAN system 10), facilities maintenance (e.g., a plurality of maintenance workers, technicians, supervisors, etc. may each be equipped with a PAN system 10), and any other operational environment in which personnel may work collaboratively and share information to maintain a COP of the environment.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, sub-combinations, and permutations of structure, operations, and/or other features described herein and in the accompanying drawing figures.

1. A method for communicating data in an operational environment, the method comprising:
forming, by a first hub computing device of a first personal area network (PAN) system deployed in an operational environment, a mesh network connection with hub computing devices of other PAN systems of a plurality of PAN systems, wherein:
the first PAN system further comprises a plurality of first sensors and a first output device configured to output a visual display to a first user corresponding the first PAN system,
the first hub computing device is separate from the first output device and the plurality of first sensors, and
the first hub computing device is communicatively coupled to the first output device and the plurality of first sensors;
receiving, by first PAN system controller software of the first hub computing device, a first message in a common messaging format and comprising first data associated with a first sensor of the plurality of first sensors;
receiving, by the first PAN system controller software of the first hub computing device, via the mesh network, and from a second hub computing device of a second PAN system of the plurality of PAN systems, a second message in the common messaging format and comprising second data associated with a second sensor of the second PAN system; and
causing, by the first hub computing device, output via the first output device of one or more visual displays based on the first data and the second data.

2. The method of claim 1, further comprising:
forwarding, by the first hub computing device, via the mesh network, and to one or more other PAN systems of the plurality of PAN systems, the second message.

3. The method of claim 1, wherein the first output device comprises an augmented reality (AR) display device worn by the first user.

4. The method of claim 1, further comprising:
receiving, by the first PAN system controller software of the first hub computing device, while disconnected from the mesh network, one or more additional messages in the common messaging format and comprising additional data associated with one or more first sensors of the plurality of first sensors; and
causing, by the first hub computing device via the first output device, output of one or more visual displays based on the additional data.

5. The method of claim 1, wherein the plurality of first sensors comprise two or more of:
a biometric sensor measuring biometric data of the first user,
a global positioning system (GPS) sensor located with the first user,
a camera,
a microphone,
a sensor configured to receive input from the first user, or
a sensor configured to measure an environment condition.

6. The method of claim 1, wherein the first hub computing device comprises:
for each of first sensor of the plurality of first sensors, a separate first sensor software container corresponding to the first sensor and configured to output messages, in the common messaging format, based on data received from the corresponding first sensor;
an output device software container, for the first output device, configured to receive messages in the common messaging format and to control the first output device based on the messages received by the output device software container, and
a PAN system controller software container comprising the first PAN system controller software, wherein the PAN system controller software container is configured to:
process messages, in the common messaging format, received from the first sensor software containers,
process messages, in the common messaging format, received via the mesh network, and
forward, via the mesh network, messages in the common messaging format.

7. The method of claim 1, wherein the common messaging format comprises, for each of first message and the second message:
a topic associated with data contained in the message,
an identifier of a sensor generating one or more of data contained in the message or data on which the data contained in the message is based,
a time associated with data from the sensor, and
an identifier of a PAN system that comprises sensor.

8. The method of claim 1, further comprising:
receiving, by the first hub computing device, from the second hub computing device, and via the mesh network, a message in the common messaging format and comprising textual data; and
causing, by the first PAN system controller software, output via the first output device of a visual display comprising the textual data.

9. The method of claim 1, wherein the second message is associated with a first type of sensor, and wherein the first PAN system lacks the first type of sensor.

10. A method for communicating data in an operational environment, the method comprising:
forming, by a first hub computing device of a first personal area network (PAN) system deployed in an operational environment, a mesh network connection with hub computing devices of other PAN systems of a plurality of PAN systems, wherein:
the first PAN system further comprises a plurality of first sensors, and
the first hub computing device is communicatively coupled to, and is separate from, the plurality of first sensors;
receiving, by first PAN system controller software of the first hub computing device, a first message in a common messaging format and comprising first data associated with a first sensor of the plurality of first sensors;
receiving, by the first PAN system controller software of the first hub computing device, via the mesh network, and from a second hub computing device of a second PAN system of the plurality of PAN systems, a second message in the common messaging format and comprising second data associated with a second sensor of the second PAN system; and
forwarding, by the first PAN system controller software, via the mesh network, and to one or more other PAN systems of the plurality of PAN systems, the first message and the second message.

11. The method of claim 10, wherein the first hub computing device is communicatively coupled to an augmented reality (AR) display device worn by a first user corresponding to the first PAN system, the method further comprising:
causing, by the first hub computing device, output via the AR display of one or more visual displays based on one or more of the first data or the second data.

12. The method of claim 10, further comprising:
receiving, by the first PAN system controller software of the first hub computing device, while disconnected from the mesh network, one or more additional messages in the common messaging format and comprising additional data associated with one or more first sensors of the plurality of first sensors; and
causing, by the first hub computing device, output of one or more visual displays based on the additional data.

13. The method of claim 10, wherein the plurality of first sensors comprise two or more of:
a biometric sensor measuring biometric data of a first user corresponding to the first PAN system,
a global positioning system (GPS) sensor located with the first user,
a camera,
a microphone,
a sensor configured to receive input from the first user, or
a sensor configured to measure an environment condition.

14. The method of claim 10, wherein the first hub computing device comprises:
for each of first sensor of the plurality of first sensors, a separate first sensor software container corresponding to the first sensor and configured to output messages, in the common messaging format, based on data received from the corresponding first sensor;
an output device software container, for a first output device associated with the first PAN system, configured to receive messages in the common messaging format and to control the first output device based on the messages received by the output device software container, and
a PAN system controller software container comprising the first PAN system controller software, wherein the PAN system controller software container is configured to:
process messages, in the common messaging format, received from the first sensor software containers,
process messages, in the common messaging format, received via the mesh network, and
forward, via the mesh network, messages in the common messaging format.

15. The method of claim 10, wherein the common messaging format comprises, for each of first message and the second message:
a topic associated with data contained in the message,
an identifier of a sensor generating one or more of data contained in the message or data on which the data contained in the message is based,
a time associated with data from the sensor, and
an identifier of a PAN system that comprises sensor.

16. The method of claim 10, wherein the second message is associated with a first type of sensor, and wherein the first PAN system lacks the first type of sensor.

17. A personal area network (PAN) system comprising:
a plurality of first sensors;
a first output device configured to output a visual display; and
a first hub computing device, communicatively coupled to the plurality of first sensors and to the first output device, configured to:
form a mesh network connection with hub computing devices of other PAN systems of a plurality of PAN systems;
receive, by first PAN system controller software of the first hub computing device, a first message in a common messaging format and comprising first data associated with a first sensor of the plurality of first sensors;
receive, by the first PAN system controller software of the first hub computing device, via the mesh network, and from a second hub computing device of a second PAN system of the plurality of PAN systems, a second message in the common messaging format and comprising second data associated with a second sensor of the second PAN system; and
cause output via the first output device of one or more visual displays based on the first data and the second data.

18. The PAN system of claim 17, wherein the first hub computing device is further configured to forward, via the mesh network, and to one or more other PAN systems of the plurality of PAN systems, the second message.

19. The PAN system of claim 17, wherein the plurality of first sensors comprise two or more of:
a biometric sensor measuring biometric data,
a global positioning system (GPS) sensor located,
a camera,
a microphone,
a sensor configured to receive input from a user, or
a sensor configured to measure an environment condition.

20. The PAN system of claim 17, wherein the first hub computing device comprises:
for each of first sensor of the plurality of first sensors, a separate first sensor software container corresponding to the first sensor and configured to output messages, in the common messaging format, based on data received from the corresponding first sensor;
an output device software container, for the first output device, configured to receive messages in the common messaging format and to control the first output device based on the messages received by the output device software container, and
a PAN system controller software container comprising the first PAN system controller software, wherein the PAN system controller software container is configured to:
process messages, in the common messaging format, received from the first sensor software containers,
process messages, in the common messaging format, received via the mesh network, and
forward, via the mesh network, messages in the common messaging format.
